(19) United States
(12) Patent Application Publication
(10) Pub. No.: US 2020/0054975 A1
(43) Pub. Date: Feb. 20, 2020

(54) Filter media comprising binder components

(71) Applicant: Hollingsworth & Vose Company, East Walpole, MA (US)

(72) Inventors: Howard Yu Belmont, Belmont, MA (US); Svetlana Krupnikov, Ashland, MA (US); Sneha Swaminathan, Merrimack, NH (US)

(73) Assignee: Hollingsworth & Vose Company, East Walpole, MA (US)

(21) Appl. No.: 15/999,636

(22) Filed: Aug. 20, 2018

(51) Int. Cl. B01D 39/16; B01D 39/18; D04H 3/115; D01F 6/62; D01F 6/66

(52) U.S. Cl. CPC B01D 39/163; B01D 39/18; B01D 2201/12; D01F 6/625; D01F 6/66; D04H 3/115

(57) ABSTRACT

Filter media comprising a non-woven web including one or more binder components are provided. In some embodiments, the non-woven web comprises fibers and one or more binder components (e.g., monocomponent binder fibers, binder particles). The binder component(s) may impart strength and/or durability to the non-woven web without adversely affecting one or more filtration properties (e.g., air permeability, efficiency, dust holding capacity). In such cases, the non-woven web may function as both a filtration and support layer. For instance, the non-woven web may trap particulate matter and allow the filter media to be pleated and/or utilized in a filter element without the need for additional support structures. Filter media described herein may be particularly well-suited for applications such as fuel filtration, hydraulic filtration, lube filtration, gas turbine filtration, air filtration, and water filtration, though the media may also be used in other applications.

### TECHNICAL FIELD

The present embodiments relate generally to filter media, and specifically, to filter media comprising a non-woven web including one or more binder components.

### BACKGROUND

Filter media can be used to remove contamination in a variety of applications such as those involving fuel, hydraulics, lube, gas turbines, air, and water. In general, filter media include one or more fiber webs. The fiber web provides a porous structure that permits fluid (e.g., air or liquid) to flow through the web. Contaminant particles (e.g., dust particles, soot particles) contained within the fluid may be trapped on the fiber web. Fiber web characteristics (e.g., pore size, fiber dimensions, fiber composition, basis weight, amongst others) affect filtration performance of the media. Although different types of filter media are available, improvements are needed.

### SUMMARY

Filter media comprising a non-woven web including one or more binder components, and related components, systems, and methods associated therewith are provided. The subject matter of this application involves, in some cases, interrelated products, alternative solutions to a particular problem, and/or a plurality of different uses of structures and compositions.

In one set of embodiments, wet-laid non-woven webs are provided. In one embodiment, a wet-laid nonwoven web comprises a first plurality of fibers, monocomponent binder fibers having a glass transition temperature of less than or equal to 70° C., and binder particles having a cross-sectional dimension greater than or equal to about 0.1 μm. The wet-laid nonwoven web has an air permeability of greater than or equal to 1 CFM and less than or equal to 500 CFM and a stiffness of greater than or equal to 500 mg and less than or equal to 50,000 mg.

In another set of embodiments, filter media are provided. In one embodiment, a filter media comprises a first layer comprising a first plurality of fibers and first monocomponent binder fibers having a glass transition temperature of less than or equal to 70° C., and a second layer comprising a second plurality of fibers. The second layer has an air permeability of less than or equal to about 150 CFM and a mean flow pore size of the second layer is less than a mean flow pore size of the first layer. The filter media has a thickness of less than or equal to about 10 mm and the filter media has a dry Mullen burst strength of greater than or equal to about 5 psi and less than or equal to about 500 psi.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic of a cross-section of a filter media, according to one set of embodiments;

FIG. 1B is a schematic of a cross-section of a filter media, according to one set of embodiments;

FIG. 1C is a schematic of a cross-section of a filter media, according to one set of embodiments;

FIG. 2 is a schematic of a cross-section of a filter media, according to certain embodiments;

FIG. 3A is a scanning electron microscope (SEM) image of a non-woven web comprising non-binder fibers, binder fibers, and binder particles, according to certain embodiments;

FIG. 3B is a SEM image of a non-woven web comprising non-binder fibers, binder fibers, and binder particles, according to certain embodiments;

FIG. 4A is a SEM image of a non-woven web comprising cellulose fibers, synthetic fibers, and binder fibers, according to certain embodiments; and

FIG. 4B is a SEM image of a non-woven web comprising cellulose fibers, synthetic fibers, and binder fibers, according to certain embodiments.

### DETAILED DESCRIPTION

Filter media comprising a non-woven web including one or more binder components are provided. In some embodiments, the non-woven web comprises fibers and one or more binder components (e.g., monocomponent binder fibers, binder particles). The binder component(s) may impart strength and/or durability to the non-woven web without adversely affecting one or more filtration properties (e.g., air permeability, efficiency, dust holding capacity). In such cases, the non-woven web may function as both a filtration and support layer. For instance, the non-woven web may trap particulate matter and allow the filter media to be pleated and/or utilized in a filter element without the need for additional support structures (e.g., scrim layer, mesh, glue beads). The filter media, described herein, may be particularly well-suited for a variety of applications such as fuel filtration, hydraulic filtration, lube filtration, air filtration, and water filtration.

Many filtration applications require the filter media to meet certain filtration standards (e.g., efficiency, dust holding capacity, pressure drop). In many conventional filter media, a tradeoff exists between these filtration properties and certain mechanical properties (e.g., strength, durability) of the filter media. Some existing filter media have tried to address this problem by adding one or more support structures (e.g., support layers) to the filter media. However, in some instances, the addition of a support structure may adversely affect one or more properties of the filter media, limit the utility of the filter media, increase the size of the filter element, and/or increase the difficulty and/or expense of manufacturing the filter media. For instance, the addition of a support structure may significantly increase the thickness of the filter media. In some cases, the increase in thickness may cause the pressure drop of the filter media to increase significantly. Post-fabrication processes, such as pleating, may also be affected by the thickness of the support structure. For instance, a thicker media may produce fewer pleats. As another example, the specific dust holding capacity (i.e., dust holding capacity per unit thickness) of the filter element may decrease due to the increase in thickness. In some instances, certain support structures may significantly impact the ease of manufacture of the filter media. For example, the additional support structure(s) may require specialized equipment or techniques to manufacture the media, require equipment different from those that would form the other layers in the filter media, and/or may significantly increase the manufacturing time or steps required to fabricate the filter media. For example, certain support structures may require a bonding step, which, in some instances, may lead to a decrease in dust holding capacity due to the nip pressure and adhesive used. Furthermore, the bonding step may also lead to a decrease in the air permeability of the filter media, which could result in an increased pressure drop.

Other existing filter media have tried to address the problem by adding and/or increasing the amount of conventional binder resins and/or conventional binder fibers in the filter media. However, in some instances, the addition and/or increase of conventional binders adversely affect one or more properties of the filter media and/or limit the utility of the filter media. For instance, many conventional binders join components within a non-woven web by producing one or more films that bridges, or otherwise connects, components within the non-woven web. These films may extend into the pore region of the non-woven web. Extension of the film(s) into the pore regions may result in blockage of at least a portion of the pores in the non-woven web. Blockage of pores in the filter media may result in an increased pressure drop, a decreased dust holding capacity, and/or a decreased efficiency for particle removal that may worsen as the amount of the conventional binder resins and/or binder fibers increases. In some instances, the film(s) produced by conventional binder resins and fibers may cause webbing and/or bundling of the fibers (e.g., bundling of fibers having a relatively small diameter). The webbing and/or bundling of the fibers may result in blockage of a significant percentage of the pores in a non-woven web. Accordingly, filter media comprising such conventional binders may not be suitable for certain applications, such as high efficiency liquid and air filters and applications that require low pressure drop and high air permeability.

There is a need for non-woven webs that are able to impart both beneficial filtration and mechanical properties without adversely affecting one or more properties of the filter media or filter element, the utility of the filter media, and/or manufacturing of the filter media.

In some embodiments, filter media comprising a non-woven web including the binder components described herein do not suffer from one or more limitations of existing and/or conventional filter media. The binder components may impart beneficial mechanical properties to the filter media without compromising certain filtration properties. For instance, the binder components may join components within the non-woven web to impart structural integrity without significantly blocking the pores of the non-woven web. In such cases, the binder components may join components with minimal or no film formation and/or generation of forces that result in bundling or webbing of fibers. Without being bound by theory, it is believed that the binder components of the present disclosure are able to bond components (e.g., fibers) in the non-woven web without requiring a significant distortion in shape (e.g., cylindrical fiber to film, particle to film). It is believed that the ability to bond components without significant distortion in shape is due to various properties of the binder component. Non-limiting examples of properties that may contribute to advantageous binding properties include glass transition temperature, melting temperature (e.g., a melting temperature significantly greater than the glass transition temperature), and melt flow index. For instance, a binder fiber having a melting temperature significantly greater than the glass transition temperature may soften and bind components at temperatures above the glass transition temperature and below the melting temperature. In some instances, the binder fiber may have a relatively low melt flow index.

In some embodiments, certain characteristics (e.g., type, weight percentage, composition, binding mechanism) of the binder components may allow the non-woven web to have mechanical properties (e.g., stiffness, Mullen burst strength, durability) comparable to certain conventional support structures. In some such cases, the non-woven web may impart sufficient stiffness to the filter media to allow the media to be self-supporting and/or pleatable without the need for additional support structures (e.g., a support layer, glue beads). In general, the non-woven web comprising the binder components described herein may serve as both a filtration and a support layer in the filter media.

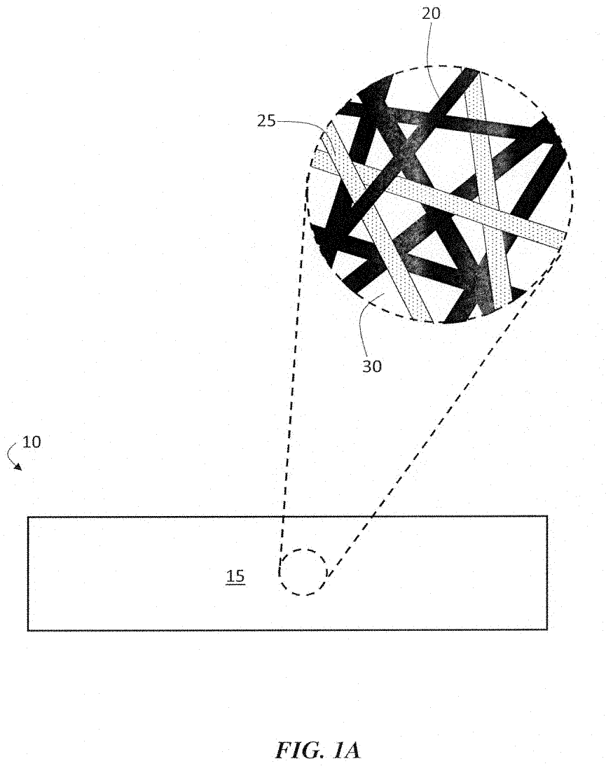

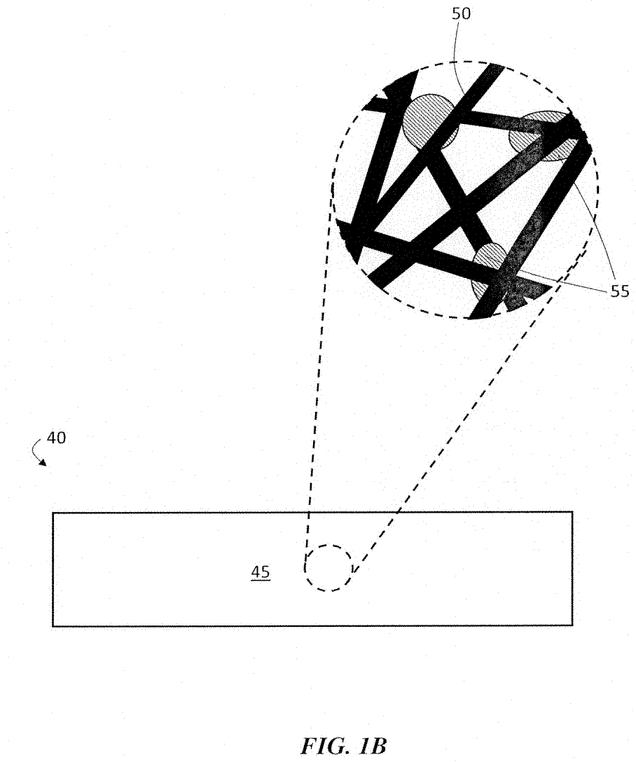

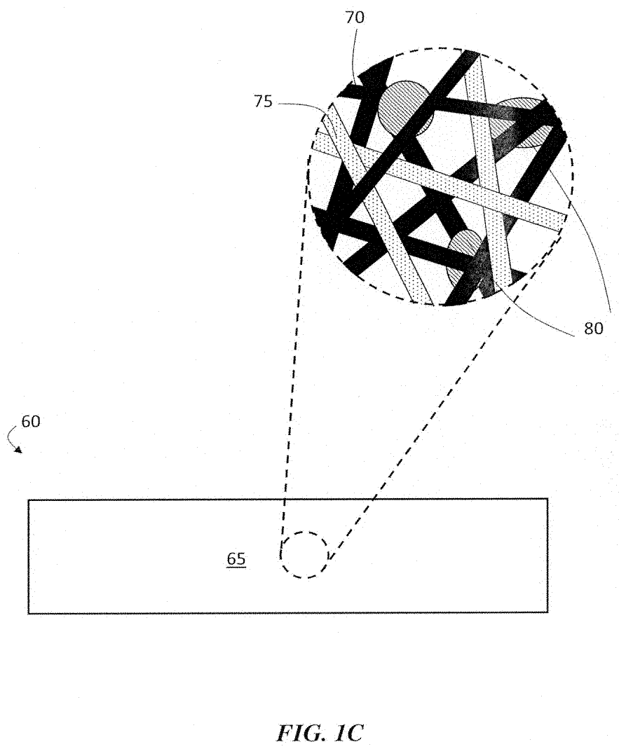

Non-limiting examples of a filter media comprising a non-woven web including one or more binder components are shown in FIGS. 1A-1C. In some embodiments, as illustrated in FIG. 1A, a filter media 10 may include a non-woven web (e.g., wet-laid non-woven web) 15. The non-woven web may comprise fibers and one or more binder components. For instance, non-woven web 15 may comprise fibers 20 (e.g., cellulose fibers and synthetic fibers, synthetic fibers and fibrillated fibers) and binder components 25. In some embodiments, the composition and/or amount of binder components 25 may be selected to impart beneficial mechanical properties to the filter media, while having relatively minimal or no adverse effects on another property (e.g., stiffness) of the filter media. Binder components 25 may join fibers 20 and/or other components (e.g., other fibers, binder fibers, binder particles) within the non-woven web. In some embodiments, binder components 25 may join components within the non-woven web without substantially blocking the pores (e.g., pore 30) of the non-woven web. In general, the one or more binder components, described herein, may impart structural integrity and enhanced mechanical properties (e.g., Gurley stiffness, Mullen burst strength, pleatability) to the filter media without comprising filtration properties.

In some embodiments, as illustrated in FIG. 1A, binder components 25 may be binder fibers (e.g., monocomponent binder fiber). The hinder fibers may comprise one or more polymers having a glass transition temperature (T_{g}) and/or a melting temperature (Tₘ). In some embodiments, the glass transition temperature of one or more polymers (e.g., all polymers, polymers on the exterior of the binder fiber) in the binder fiber and/or the binder fiber may be relatively low. For instance, one or more polymers in the binder fiber and/or the binder fiber may have a glass transition temperature of less than about 70° C. In some embodiments, the glass transition temperature of one or more polymers (e.g., all polymers, polymers on the exterior of the binder fiber) in the binder fiber and/or the binder fiber may be less than the glass transition temperature of another component (e.g., all non-binder components) in the non-woven web. In some cases, the glass transition temperature of the binder fiber and/or one or more polymers in the binder fiber may be less than the glass transition temperature of another fiber in the non-woven web. For example, binder components 25 (e.g., binder fibers) may have a glass transition temperature that is less than the glass transition temperature of fibers 20. In certain embodiments, the melting temperature of one or more polymers (e.g., all polymers, polymers on the exterior of the binder fiber) in the binder fiber and/or the binder fiber may be less than the melting temperature of another component (e.g., all non-binder components) in the non-woven web. In some cases, the melting temperature of the binder fiber and/or one or more polymers in the binder fiber may be less than the melting temperature of another fiber in the non-woven web. For example, binder components 25 (e.g., binder fibers) may have a melting temperature that is less than the melting temperature of fiber 20. In certain embodiments, the non-woven web comprises a binder fiber (e.g., a monocomponent binder fiber), and the binder fiber comprises polylactic acid.

In some embodiments, the binder component may be a binder particle (e.g., cross-linked binder particle). For example, as illustrated in FIG. 1B, filter media 40 may comprise non-woven web 45. The non-woven web (e.g., wet-laid non-woven web) may comprise fibers 50 (e.g., cellulose fibers and synthetic fibers, synthetic fibers and fibrillated fibers) and binder particles 55. The binder particles may join fibers 50 and/or other components (e.g., other fibers, binder fibers, binder particles) within the non-woven web. In some embodiments, binder component 55 may join components within the non-woven web without substantially blocking the pores of the non-woven web, as described above. In some embodiments, binder particles 55 may comprise one or more polymers. In some such cases, one or more polymers in binder particles 55 may be cross-linked. For instance, the binder particles may comprise one or more thermoset polymers and/or precursors thereof (e.g., monomer, oligomer) that cross-link upon heating at a certain temperature (e.g., a cure temperature). For example, in certain embodiments, the binder particles comprise a phenolic resin (e.g., from a dry phenolic resin system). In some embodiments, cross-linked binder particles (e.g., binder particles 55) may exhibit increased chemical durability and enhanced mechanical properties compared to uncross-linked binder particles.

In some, but not necessarily all embodiments, one or more of the binder components (e.g., binder fiber, binder particle) has a substantially uniform distribution across one or more dimensions of non-woven web, or one or more layers of a filter media. For example, in some instances, it may be beneficial for a binder component to be substantially uniformly distributed across the thickness of a non-woven web, a filter media, or a layer thereof (e.g., to provide consistent stiffness and/or strength throughout the thickness direction). In certain embodiments, the binder particles (e.g., dry phenolic binder particles) are substantially uniformly distributed across the thickness of a non-woven web, filter media, or layer thereof. In some such embodiments, the binder particles may be distributed throughout the interior of the non-woven web and/or layer.

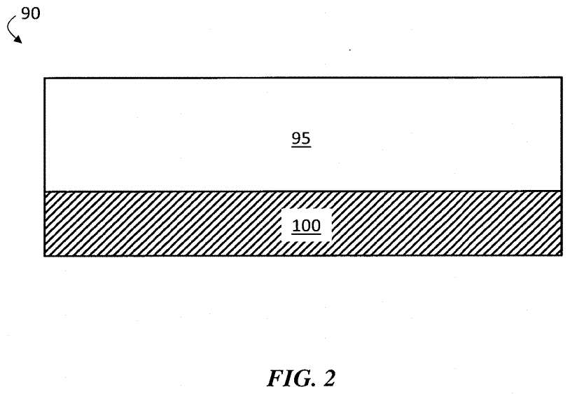

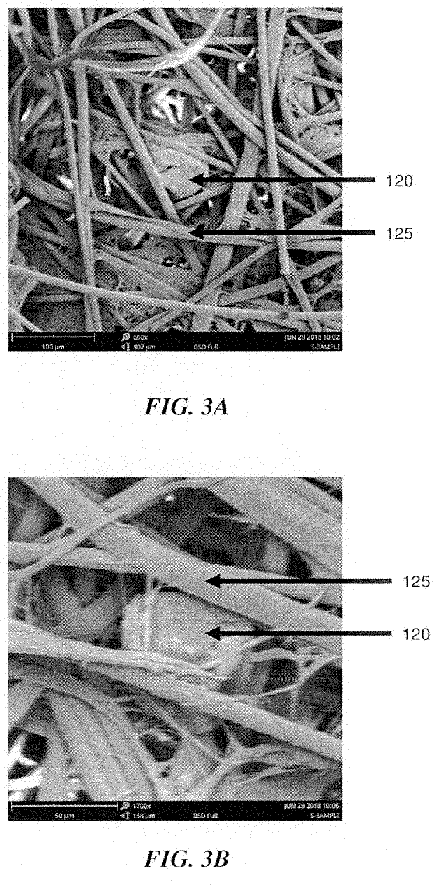

In some embodiments, a filter media may comprise a non-woven web including two or more binder components. For instance, as illustrated in FIG. 1C, a filter media 60 may include a non-woven web (e.g., wet-laid non-woven web) 65. The non-woven web may comprise fibers 70 (e.g., cellulose fibers and synthetic fibers, synthetic fibers and fibrillated fibers), a first binder component, and a second binder component. In some embodiments, the first binder component may be a binder fiber and the second binder component may be a binder particle. For example, as illustrated in FIG. 1C, non-woven web 65 may comprise fibers 70, binder fibers 75, and binder particles 80. In certain embodiments, the first binder component may be a binder fiber and the second binder component may be a different binder fiber. In some instances, the first binder component may be a binder particle and the second binder component may be a different binder particle. The two or more binder components may join fibers 70 and/or other components (e.g., other fibers, binder fibers, binder particles) within the non-woven web. In some embodiments, the two or more binder components may join components within the non-woven web without substantially blocking the pores of the non-woven web, as described herein. In some embodiments, a non-woven web comprising two or more binder components, described herein, may have improved mechanical properties (e.g., stiffness, burst strength) compared to a non-woven web comprising a single or no binder component. A non-limiting example of a non-woven web comprising a binder particle and a binder fiber are shown in FIGS. 3A-3B. FIGS. 3A and 3B show SEM images of a non-woven web comprising binder particles 120 and binder fibers 125.

Regardless of the type and number of binder components, in some embodiments, the filter media may also comprise a second layer. For instance, as illustrated in FIG. 2, filter media 90 may comprise a non-woven web 95 including binder components and a second layer 100. In some embodiments, second layer 100 may be an efficiency layer. For example, filter media 90 may comprise non-woven web 95 including a plurality of fibers (e.g., cellulose fibers and synthetic fibers, synthetic fibers and fibrillated fibers) and binder components and a second layer (e.g., efficiency layer). In some instances, second layer 100 may be an efficiency layer comprising fibrillated fibers (e.g., fibrillated lyocell fibers, fibrillated acrylic fibers). In certain instances, second layer 100 may be an efficiency layer comprising continuous fibers (e.g., meltblown fibers, electrospun fibers). In certain instances, second layer 100 may be an efficiency layer comprising synthetic fibers (e.g., synthetic staple fibers). In certain instances, second layer 100 may be an efficiency layer comprising glass fibers. In some embodiments, the second layer (e.g., efficiency layer) may comprise one or more binder components described herein with respect to the non-woven web (e.g., non-woven web 95). For instance, the second layer may comprise a binder fiber and/or binder particle as described herein. In some embodiments, non-woven web 95 and the second layer 100 may be directly adjacent. In other embodiments, non-woven web 95 and the second layer 100 may be adjacent to one another, and one or more intervening layers may separate the layers. In some embodiments, filter media 90 may comprise one or more optional layers (e.g., pre-filter layer, efficiency layer) positioned upstream and/or downstream of layers 95 and 100. For instance, filter media 90 may comprise one or more optional layers upstream of non-woven web 95 and the second layer 100. In general, the one or more optional layers may be any suitable layer (e.g., a scrim layer, a substrate layer, an efficiency layer, a capacity layer, a spacer layer).

As used herein, when a layer is referred to as being “adjacent” another layer, it can be directly adjacent the layer, or an intervening layer also may be present. A layer that is “directly adjacent” another layer means that no intervening layer is present.

In some embodiments, one or more layers in the filter media may be designed to be discrete from another layer. That is, the fibers from one layer do not substantially intermingle (e.g., do not intermingle at all) with fibers from another layer. For example, with respect to FIG. 2, in one set of embodiments, fibers from the non-woven web do not substantially intermingle with fibers of the second layer (e.g., efficiency layer). Discrete layers may be joined by any suitable process including, for example, lamination, thermo-dot bonding, calendering, ultrasonic processes, wet-laid processes, and/or by adhesives, as described in more detail below. It should be appreciated, however, that certain embodiments may include one or more layers that are not discrete with respect to one another. In some such embodiments, fibers from one layer may intermingle with fibers from another layer, The intermingling of fibers from one layer and another layer (e.g., at or near the interface between the layers) may lead to the filter media having a transition layer between one layer and another layer. For example, with respect to FIG. 2, in one set of embodiments, fibers from the non-woven web intermingle with fibers of the second layer (e.g., efficiency layer).

It should be understood that the configurations of the layers shown in the figures are by way of example only, and that in other embodiments, filter media including other configurations of layers may be possible. For example, while the non-woven web and the second layer are shown in a specific order in FIG. 2, other configurations are also possible. For instance, the filter media may comprise non-woven web 95 and may not comprise second layer 100 (e.g., efficiency layer). In some such embodiments, an article (e.g., filter media) may consist essentially of non-woven web 95. In certain embodiments, the article may comprise non-woven web 95 and another layer. It should be appreciated that terms, such as “second”, “third”, etc. layers, as used herein, refer to different layers within the media, and are not meant to be limiting with respect to the location of that layer. Furthermore, in some embodiments, additional layers may be present in addition to the ones shown in the figures. It should also be appreciated that not all layers shown in the figures need be present in some embodiments.

As described herein, a filter media may comprise a non-woven web including one or more binder components. The binder components may serve to join components of the non-woven web and impart beneficial mechanical properties to the filter media. In general, the non-woven web may comprise any suitable number of binder components. In some instances, the non-woven web may comprise a single binder component (e.g., binder particle). In some cases, non-woven webs comprising a single binder components described herein may have enhanced mechanical properties compared to a non-woven web comprising no binder component or certain conventional binder material. In some embodiments, the non-woven web may comprise two different binder components. For instance, in some embodiments, the non-woven web may comprise a binder particle and a binder fiber. In some instances, the non-woven web may comprise two different binder fibers. In certain cases, the non-woven web may comprise two different binder particles. In certain embodiments, the non-woven may comprise three or more (e.g., four or more, five or more) different binder components. In certain embodiments, non-woven webs comprising two or more binder components may have enhanced mechanical properties compared to a non-woven web comprising a single binder component, no binder components, and/or conventional binder material.

As noted above, the non-woven web may comprise certain types of binder components. In general, the non-woven web may comprise any suitable binder component having the properties described herein. In some embodiments, the non-woven web may comprise a single type of binder components. For instance, the non-woven web may comprise two or more different binder fibers. In some instances, the non-woven web may comprise two or more different binder particles. In some embodiments, the non-woven web may comprise different types of binder components. For instance, the non-woven web may comprise a first binder component and a second binder component. The first and second binder components may be different types. For example, the first binder component may be a binder fiber and the second binder component may be a binder particle. In some embodiments, non-woven webs comprising different types of binder components may have enhanced mechanical properties compared to a non-woven web comprising a single type of binder component and/or conventional binder material.

In some embodiments, the non-woven web may comprise a binder fiber as a binder component. In some embodiments, the binder fiber may comprise one or more polymers (e.g., thermoplastic polymer, polylactic acid). The one more polymers may have a glass transition temperature and/or a melting temperature. In some embodiments, the glass transition temperature of the one or more polymers and/or binder fiber may be selected to impart beneficial mechanical properties (e.g., elongation, strength, flexibility, stiffness) to the non-woven web. For instance, in some embodiments, the glass transition temperature of the one or more polymers and/or binder fiber may be relatively low (e.g., less than or equal about 70° C.).

In some embodiments, the glass transition temperature of the one or more polymers and/or binder fibers (e.g., monocomponent binder fibers) may be greater than or equal to about −140° C., greater than or equal to about −125° C., greater than or equal to about −100° C., greater than or equal to about −75° C., greater than or equal to about −50° C., greater than or equal to about −25° C., greater than or equal to about 0° C., greater than or equal to about 10° C., greater than or equal to about 20° C., greater than or equal to about 30° C., greater than or equal to about 45° C., or greater than or equal to about 60° C. In some instances, the glass transition temperature of the one or more polymers and/or binder fibers may be less than or equal about 80° C., less than or equal about 70° C., less than or equal to about 65° C., less than or equal to about 60° C., less than or equal to about 50° C., less than or equal to about 40° C., or less than or equal to about 20° C. Combinations of the above-referenced ranges are also possible (e.g., greater than or equal to about 20° C. and less than or equal to about 70° C.). Other values of glass transition temperature of the one or more polymers and/or binder fibers are also possible. The glass transition temperature of the one or more polymers and/or binder fibers may be determined using differential scanning calorimetry (DSC), thermomechanical analysis (TMA), dynamic mechanical analysis (DMA), or may be obtained from a manufacturer's specifications. Unless indicated otherwise, the values of glass transition temperature described herein are determined by differential scanning calorimetry (DSC) using the ASTM D3418 standard test (2015).

In some embodiments, the melting temperature of the one or more polymers and/or binder fibers (e.g., monocomponent binder fiber) may be selected to impart beneficial mechanical properties to the non-woven web. In some embodiments, the one or more polymers and/or binder fibers may have a melting temperature of greater than or equal to about 100° C., greater than or equal to about 110° C., greater than or equal to about 120° C., greater than or equal to about 110° C., greater than or equal to about 130° C., greater than or equal to about 140° C., greater than or equal to about 150° C., greater than or equal to about 160° C., greater than or equal to about 175° C., or greater than or equal to about 200° C. In some embodiments, the one or more polymers and/or binder fibers may have a melting temperature of less than or equal to 250° C., less than or equal to 240° C., less than or equal to 230° C., less than or equal to 220° C., less than or equal to 210° C., less than or equal to 200° C., less than an or equal to 190° C., less than an or equal to 180° C., less than an or equal to 170° C., less than an or equal to 160° C., less than an or equal to 150° C., less than an or equal to 140° C., less than an or equal to 130° C., or less than or equal to 120° C. It should be understood that all combinations of the above-referenced ranges are possible (e.g., greater than or equal to about 100° C. and less than or equal to about 250° C.). Other values and ranges of the melting temperature of the one or more polymers and/or binder fibers are also possible.

In some embodiments, the melting temperature of the one or more polymers and/or the binder fibers may be less than the melting temperature of another component in the non-woven web. For instance, in some embodiments, the melting temperature of the one or more polymers and/or the binder fibers may be less than certain fibers within the non-woven web. In certain embodiments in which the melting temperature of the one or more polymers and/or the binder fibers is less than the melting temperature of another component in the non-woven web, the difference between the melting temperature of the one or more polymers and/or the binder fibers and another component in the non-woven web may be greater than or equal to about 10° C. (e.g., greater than or equal to about 20° C., greater than or equal to about 30° C., greater than or equal to about 40° C.).

In some embodiments, the melt flow index of the binder fibers may be selected to impart beneficial mechanical properties to the non-woven web. For instance, in some embodiments, the melt flow index of the binder fibers (e.g., monocomponent binder fibers) may be greater than or equal to about 1 g/10 minutes, greater than or equal to about 3 g/10 minutes, greater than or equal to about 5 g/10 minutes, greater than or equal to about 10 g/10 minutes, greater than or equal to about 20 g/10 minutes, greater than or equal to about 30 g/10 minutes, greater than or equal to about 50 g/10 minutes, greater than or equal to about 100 g/10 minutes, greater than or equal to about 250 g/10 minutes, greater than or equal to about 500 g/10 minutes, greater than or equal to about 750 g/10 minutes, greater than or equal to about 1,000 g/10 minutes, greater than or equal to about 1,250 g/10 minutes, greater than or equal to about 1,500 g/10 minutes, greater than or equal to about 1,750 g/10 minutes, or greater than or equal to about 2,000 g/10 minutes. In some instances, the melt flow index of the binder fibers may be less than or equal to about 2,500 g/10 minutes, less than or equal to about 2,250 g/10 minutes, less than or equal to about 2,000 g/10 minutes, less than or equal to about 1,900 g/10 minutes, less than or equal to about 1,500 g/10 minutes, less than or equal to about 1,250 g/10 minutes, less than or equal to about 1,000 g/10 minutes, less than or equal to about 750 g/10 minutes, less than or equal to about 500 g/10 minutes, less than or equal to about 200 g/10 minutes, less than or equal to about 100 g/10 minutes, less than or equal to about 75 g/10 minutes, less than or equal to about 50 g/10 minutes, or less than or equal to about 25 g/10 minutes. It should be understood that all combinations of the above-referenced ranges are possible (e.g., greater than or equal to about 5 g/10 minutes and less than or equal to about 2500 g/10 minutes, greater than or equal to about 30 g/10 minutes and less than or equal to about 1,900 g/10 minutes, greater than or equal to about 5 g/10 minutes and less than or equal to about 50 g/10 minutes, greater than or equal to about 5 g/10 minutes and less than or equal to about 25 g/10 minutes). Other values of melt flow index are also possible.

As used herein, melt flow index is measured according to the standard ASTM D1238/ISO 1133 (2005), which uses a melt flow tester. For example, about 4 to 5 grams of the polymer composition are placed into a furnace and the material is packed properly to avoid formation of air pockets in the melt flow tester. The sample is preheated for 6 min at 210° C. After the pre-heat step, 2.16 kg of the polymer composition is placed on a piston which causes the molten polymer to flow. Test results, i.e., weight of the melt after desired time, are displayed at the end of the test.

In some embodiments, the binder fiber may be a monocomponent binder fiber. As used herein, the term “monocomponent fiber” refers to a fiber that is made of only one polymer type. For instance, the monocomponent binder fiber may comprise a thermoplastic polymer. In other embodiments, the binder fiber may be a bicomponent fiber. Each component of the bicomponent fiber can have a different melting temperature. For example, the fibers can include a core and a sheath where the activation temperature of the sheath is lower than the melting temperature of the core. The core/sheath binder fibers can be concentric or non-concentric. Other exemplary bicomponent fibers can include split fiber fibers, side-by-side fibers, and/or “island in the sea” fibers.

In general, the binder fibers may comprise any suitable polymers having one or more properties described herein. Non-limiting examples of polymers that the binder fiber may comprise include polylactic acid, polyglycolic acid, poly(ethyl methacrylate), poly(propyl methacrylate), poly(butylmethacrylate), polydimethylsiloxane, polyvinyldifluoride (PVDF), polypropylene, polyvinylfluoride, thermoplastic polyesters (e.g., polyethylene terephthalate, polybutylene terephthalate), polyvinyl alcohol, acrylic, acrylonitrile butadiene styrene (ABS), aramid polymers (e.g., aromatic polyamide), cellulosic polymers (e.g., cellulose acetate (CA), cellulose acetate butyrate (CAB), cellulose acetate phthalate (CAP), cellulose nitrate (CN)), polyethylene vinylacetate (EVA), polypropylene (e.g., expanded polypropylene), fluoroplastics (e.g., polytetrafluoroethylene (PTFE), fluorinated ethylene propylene (FEP)), polyamides (e.g., nylons, Nylon 6, Nylon 66), polyaryletheretherketone, polybutene-1, polycarbonates, polyacetals (e.g., polyoxymethylene (POM)), polyethylene (e.g., high density polyethylene, low density polyethylene, linear low-density polyethylene (LLDPE)), polyphenylene oxide, polyphenylene sulphide, polymethylpentene, general purpose polystyrene, high impact polystyrene, polyvinyl chloride, styrene acrylonitrile, acrylonitrile styrene acrylate, thermoplastic elastomers, thermoplastic rubbers, copolymers thereof, and combinations thereof. In some embodiments, the binder fibers may comprise a thermoplastic polymer. In certain embodiments, the binder fiber may comprise polylactic acid, polyglycolic acid, poly(ethyl methacrylate), poly(propyl methacrylate), poly(butylmethacrylate), polydimethylsiloxane, Nylon 6, Nylon 66, polyvinyldifluoride (PVDF), polypropylene, polyvinylfluoride, copolymers thereof, or combinations thereof.

As noted above, the binder fibers may join components in the non-woven web. In some embodiments, the binder fiber may join components after exposure to a temperature above the glass transition temperature and/or melting temperature of one or more polymers in the binder fiber and/or the binder fiber for a certain period of time. In certain embodiments, exposure of the binder fiber to a temperature above the glass transition temperature and/or melting temperature for a certain period of time may change the shape of at least a portion of the binder fibers in the non-woven web. In some instances, the exposure may change the binder fiber from a substantially cylindrical shape to a non-cylindrical shape.

In some embodiments, the binder fiber may have a substantially cylindrical shape. In some such embodiments, the binder fibers may have an average diameter of less than or equal to about 100 μm, less than or equal to about 80 μm, less than or equal to about 60 μm, less than or equal to about 40 μm, less than or equal to about 30 μm, less than or equal to about 20 μm, less than or equal to about 10 μm, less than or equal to about 5 μm, less than or equal to about 2 μm, less than or equal to about 1 μm, less than or equal to about 0.75 μm, or less than or equal to about 500 nm. In some instances, the average diameter of the binder fibers (e.g., substantially cylindrical binder fibers) may be greater than or equal to about 50 nm, greater than or equal to about 75 nm, greater than or equal to about 100 nm, greater than or equal to about 200 nm, greater than or equal to about 350 nm, greater than or equal to about 500 nm, greater than or equal to about 0.75 μm, greater than or equal to about 1 μm, greater than or equal to about 2 μm, greater than or equal to about 5 μm, or greater than or equal to about 10 μm, greater than or equal to about 15 μm, greater than or equal to about 20 μm, greater than or equal to about 30 μm, greater than or equal to about 40 μm, greater than or equal to about 50 μm, greater than or equal to about 60 μm, greater than or equal to about 70 μm, greater than or equal to about 80 μm, or greater than or equal to about 90 μm. Combinations of the above-referenced ranges are also possible. For instance, in certain embodiments, the average diameter of the binder fibers may be, for example, greater than or equal to about 100 nm and less than or equal to about 80 μm, greater than or equal to about 100 nm and less than or equal to about 40 μm, greater than or equal to about 5 μm and less than or equal to about 50 μm, or greater than or equal to about 1 μm and less than or equal to about 10 μm. The average diameter of the binder fibers can be determined, for example, by analyzing a Scanning Electron Microscopy (SEM) image

In some embodiments, the substantially cylindrical binder fibers in the non-woven web may have an average length of greater than or equal to about 0.2 mm, greater than or equal to about 0.3 mm, greater than or equal to about 0.5 mm, greater than or equal to about 0.8 mm, greater than or equal to about 1 mm, greater than or equal to about 3 mm, greater than or equal to about 6 mm, greater than or equal to about 9 mm, greater than or equal to about 12 mm, greater than or equal to about 15 mm, greater than or equal to about 18 mm, greater than or equal to about 20 mm, greater than or equal to about 22 mm, greater than or equal to about 25 mm, greater than or equal to about 28 mm, greater than or equal to about 30 mm, greater than or equal to about 32 mm, greater than or equal to about 35 mm, greater than or equal to about 38 mm, greater than or equal to about 40 mm, greater than or equal to about 42 mm, or greater than or equal to about 45 mm. In some instances, the substantially cylindrical binder fibers may have an average length of less than or equal to about 100 mm, less than or equal to about 85 mm, less than or equal to about 70 mm, less than or equal to about 60 mm, less than or equal to about 50 mm, less than or equal to about 45 mm, less than or equal to about 40 mm, less than or equal to about 35 mm, less than or equal to about 30 mm, less than or equal to about 27 mm, less than or equal to about 25 mm, less than or equal to about 22 mm, less than or equal to about 20 mm, less than or equal to about 18 mm, less than or equal to about 15 mm, less than or equal to about 12 mm, less than or equal to about 9 mm, less than or equal to about 6 mm, less than or equal to about 3 mm, or less than or equal to about 1 mm. All suitable combinations of the above-referenced ranges are also possible (e.g., greater than or equal to about 0.2 mm and less than or equal to about 100 mm, greater than or equal to about 0.2 mm and less than or equal to about 15 mm, greater than or equal to about 1 mm and less than or equal to about 70 mm).

In some embodiments, the binder fibers may be non-cylindrical. A non-cylindrical fiber is generally a fiber that has a long axis and a cross-sectional shape of the fiber perpendicular to the long axis that is substantially non-circular. For example, the cross-sectional shape, in accordance with certain embodiments, may have an aspect ratio (e.g., largest cross-sectional dimension to smallest cross-sectional dimension) of greater than 1. For instance, in some embodiments, the aspect ratio of the cross-sectional shape of a non-cylindrical fiber is greater than or equal to 1.1, greater than or equal to 1.2, greater than or equal to 1.5, greater than or equal to 2, greater than or equal to 3, or more. In some instances, the aspect ratio of the cross-sectional shape of a non-cylindrical fiber is less than or equal to 10, less than or equal to 9, less than or equal to 8, less than or equal to 6, less than or less than or equal to 5. All combinations of the above ranges are possible (e.g., an aspect ratio of greater than or equal to 1.5 and less than or equal to 10). Other combinations are possible. In some embodiments, the non-cylindrical fiber may have a non-circular cross-section and may have an aspect ratio of about 1. It is generally apparent to a person of ordinary skill in the art whether a fiber is non-cylindrical. For example, an SEM image may, in some cases, be used to determine whether a fiber is non-cylindrical.

In some embodiments, the non-cylindrical binder fibers may have a largest cross-sectional dimension of less than or equal to about 500 μm, less than or equal to about 400 μm, less than or equal to about 300 μm, less than or equal to about 200 μm, less than or equal to about 100 μm, less than or equal to about 50 μm, less than or equal to about 30 μm, less than or equal to about 20 μm, less than or equal to about 10 μm, less than or equal to about 5 μm, or less than or equal to about 2 μm. In some instances, the non-cylindrical binder fibers may have a largest cross-sectional dimension of greater than or equal to about 50 nm, greater than or equal to about 75 nm, greater than or equal to about 100 nm, greater than or equal to about 200 nm, greater than or equal to about 300 nm, greater than or equal to about 500 nm, greater than or equal to about 0.75 μm, greater than or equal to about 1 μm, greater than or equal to about 2 μm, greater than or equal to about 5 μm, or greater than or equal to about 10 μm, greater than or equal to 15 μm, greater than or equal to about 20 μm, greater than or equal to about 30 μm, or greater than or equal to about 40 μm. It should be understood that all combinations of the above-referenced ranges are possible (e.g., greater than or equal to about 100 nm and less than or equal to about 400 μm, greater than or equal to about 100 nm and less than or equal to 80 μm, greater than or equal to about 5 μm and less than or equal to about 50 μm). Other values and ranges of the largest cross-sectional dimension of the non-cylindrical binder fibers are also possible. The largest cross-sectional dimension of the non-cylindrical binder fibers can be determined, for example, by analyzing an SEM image.

In some embodiments, the non-cylindrical binder fibers may have an average length of greater than or equal to about 0.2 mm, greater than or equal to about 0.3 mm, greater than or equal to about 0.5 mm, greater than or equal to about 0.8 mm, greater than or equal to about 1 mm, greater than or equal to about 3 mm, greater than or equal to about 6 mm, greater than or equal to about 9 mm, greater than or equal to about 12 mm, greater than or equal to about 15 mm, greater than or equal to about 18 mm, greater than or equal to about 20 mm, greater than or equal to about 22 mm, greater than or equal to about 25 mm, greater than or equal to about 28 mm, greater than or equal to about 30 mm, greater than or equal to about 32 mm, greater than or equal to about 35 mm, greater than or equal to about 38 mm, greater than or equal to about 40 mm, greater than or equal to about 42 mm, or greater than or equal to about 45 mm. In some instances, the non-cylindrical binder fibers may have an average length of less than or equal to about 100 mm, less than or equal to about 85 mm, less than or equal to about 70 mm, less than or equal to about 65 mm, less than or equal to about 60 mm, less than or equal to about 55 mm, less than or equal to about 50 mm, less than or equal to about 45 mm, less than or equal to about 40 mm, less than or equal to about 35 mm, less than or equal to about 30 mm, less than or equal to about 27 mm, less than or equal to about 25 mm, less than or equal to about 22 mm, less than or equal to about 20 mm, less than or equal to about 18 mm, less than or equal to about 15 mm, less than or equal to about 12 mm, less than or equal to about 9 mm, less than or equal to about 6 mm, less than or equal to about 3 mm, or less than or equal to about 1 mm. All suitable combinations of the above-referenced ranges are also possible (e.g., greater than or equal to about 0.2 mm and less than or equal to about 100 mm, greater than or equal to about 0.5 mm and less than or equal to about 65 mm).

In some embodiments, the non-woven web may comprise a relatively high weight percentage of binder fibers. In some embodiments, the weight percentage of binder fibers in the non-woven web may be greater than or equal to about 1%, greater than or equal to about 2%, greater than or equal to about 3%, greater than or equal to about 5%, greater than or equal to about 8%, greater than or equal to about 10%, greater than or equal to about 12%, greater than or equal to about, greater than or equal to about 15%, greater than or equal to about 20%, greater than or equal to about 25%, greater than or equal to about 30%, greater than or equal to about 35%, or greater than or equal to about 40%, by weight. In some instances, the weight percentage of binder fibers in the non-woven web may be less than or equal to about 50%, less than or equal to about 45%, less than or equal to about 40%, less than or equal to about 35%, or less than or equal to about 30% by weight, e.g., based on the total weight of fibers in the non-woven web. Combinations of the above-referenced ranges are possible (e.g., greater than or equal to about 1% and less than or equal to about 50%, greater than or equal to about 10% and less than or equal to about 50%, greater than or equal to about 10% and less than or equal to about 30%). In some embodiments, the above weight percentages are based on the weight of the total dry solids of the non-woven web.

In some embodiments, the non-woven web may comprise a binder particle (e.g., solid binder particles) as a binder component. The binder particles (e.g., cross-linked binder particles) may serve to join components of the non-woven web without blocking the pores of the non-woven web. The binder particles may be incorporated into the non-woven web in particulate form (e.g., as solid binder particles). For instance, the binder particles may be incorporated into the non-woven web, e.g., in a substantially dry form. In some embodiments, binder particles may be incorporated into the non-woven web without the aid of a liquid carrier. For example, binder particles comprising a formulated resin system (e.g., phenolic resin system) may be incorporated into the non-woven web in a substantially dry form using the beater addition method, as described in more detail below. It should be understood that binder particles as described herein do not refer to particles while present in a liquid emulsion resin, which are typically stabilized by a surfactant, such as in latex resins.

In some embodiments, the binder particles (e.g., solid binder particles) may comprise one or more polymers and/or a precursor thereof (e.g., monomers, oligomers). In certain embodiments, the binder particles may comprise one or more polymers. The polymers in the binder particles may be selected to impart beneficial mechanical properties to the non-woven web. For instance, at least some of the polymers in the binder particle may be a thermoset. In some cases, binder particles comprising one or more thermoset polymers may impart thermal and chemical durability to the non-woven web. In certain embodiments, the binder particle may comprise one or more thermoplastic polymers.

In some embodiments, the binder particles (e.g., solid binder particles) may comprise one or more components of a cure system. In some such embodiments, the binder particles may comprise one or more monomers, oligomers, and/or polymers. The cure system may be a dry cure system. In such cases, the binder particles may be a solid binder particles comprising one or more dry components from the dry cure system. In certain embodiments, the cure system may be a formulated resin system (e.g., dry thermoset resin system, dry phenolic resin system). In some embodiments, the binder particles may also comprise other components of the cure system, such as one or more initiators and/or one or more reactive curatives. In some embodiments, in which the binder particles comprises one or more components of a cure system, the binder particles may be cured within the non-woven web. In some such embodiments, curing the binder particles may produce a cross-linked polymer binder particle. Cross-linking of the binder particle, which involves the formation of chemical bonds, may produce a relatively rigid three-dimensional network of polymers. In certain embodiments, cross-linking may impart mechanical and chemical durability to the binder particle. For example, the binder particles may be less susceptible to deleterious chemical reactions with or dissolution in materials (e.g., fluids) that may come into contact with the binder particle.

In some embodiments, the binder particles may comprise any suitable polymers or precursors thereof. Non-limiting examples of suitable polymers or precursors include phenolic, acrylics, styrene, styrene acrylic, butadiene, vinyl acrylic, acrylic-epoxy, acrylic-urethane hybrids, urethane dispersions of polyether, aromatic urethanes, aliphatic urethanes, vinyl acetates, acrylonitrile butadiene, cellulosics, olefins, copolymers thereof, and combinations thereof.

In general, the binder particle may have any suitable size and shape. For instance, in some embodiments, the average largest cross-sectional dimension of the binder particle may be less than or equal to about 1.5 mm, less than or equal to about 1.4 mm, less than or equal to about 1.2 mm, less than or equal to about 1 mm, less than or equal to about 750 μm, less than or equal to about 700 μm, less than or equal to about 650 μm, less than or equal to about 600 μm, less than or equal to about 550 μm, less than or equal to about 500 μm, less than or equal to about 450 μm, less than or equal to about 400 μm, less than or equal to about 300 μm, less than or equal to about 200 μm, less than or equal to about 100 μm, less than or equal to about 50 μm, less than or equal to about 40 μm, less than or equal to about 30 μm, less than or equal to about 20 μm, less than or equal to about 15 μm, less than or equal to about 10 μm, less than or equal to about 8 μm, less than or equal to about 5 μm, or less than or equal to about 2 μm. In some instances, the average largest cross-sectional dimension of the binder particles may be greater than or equal to about 1 μm, greater than or equal to about 2 μm, greater than or equal to about 5 μm, greater than or equal to about 8 μm, greater than or equal to about 10 μm, greater than or equal to about 20 μm, greater than or equal to about 35 μm, greater than or equal to about 50 μm, greater than or equal to about 75 μm, greater than or equal to about 100 μm, or greater than or equal to about 200 μm. It should be understood that all combinations of the above-referenced ranges are possible (e.g., greater than or equal to about 1 nm and less than or equal to about 1.5 mm, greater than or equal to 50 μm and less than or equal to 500 μm). Other values and ranges of the largest cross-sectional dimension of the binder particles are also possible. The largest cross-sectional dimension of the binder particles can be determined using SEM.

In some embodiments, the non-woven web may comprise a relatively high weight percentage of binder particles. In some embodiments, the weight percentage of binder particles in the non-woven web may be greater than or equal to about 0.1%, greater than or equal to about 0.2%, greater than or equal to about 0.3%, greater than or equal to about 0.5%, greater than or equal to about 0.8%, greater than or equal to about 1%, greater than or equal to about 2%, greater than or equal to about 3%, greater than or equal to about 5%, greater than or equal to about 8%, greater than or equal to about 10%, greater than or equal to about 12%, greater than or equal to about, greater than or equal to about 15%, greater than or equal to about 20%, greater than or equal to about 25%, or greater than or equal to about 30% by weight, e.g., based on the weight of the total dry solids of the non-woven web. In some instances, the weight percentage of the binder particles in the non-woven web may be less than or equal to about 40%, less than or equal to about 35%, less than or equal to about 30%, less than or equal to about 28%, less than or equal to about 25%, less than or equal to about 22%, less than or equal to about 20%, less than or equal to about 15%, less than or equal to about 12%, less than or equal to about 10%, less than or equal to about 8%, less than or equal to about 5%, less than or equal to about 3%, less than or equal to about 2%, or less than or equal to about 1% by weight, e.g., based on the weight of the total dry solids of the non-woven web. Combinations of the above-referenced ranges are possible (e.g., greater than or equal to about 0.1% and less than or equal to about 40%, greater than or equal to about 0.2% and less than or equal to about 25%).

In some embodiments, the non-woven web may comprise a relatively high weight percentage of binder components. In some embodiments, the total weight percentage of binder components in the non-woven web may be greater than or equal to about 0.1%, greater than or equal to about 0.2%, greater than or equal to about 0.3%, greater than or equal to about 0.5%, greater than or equal to about 0.8%, greater than or equal to about 1%, greater than or equal to about 2%, greater than or equal to about 3%, greater than or equal to about 5%, greater than or equal to about 8%, greater than or equal to about 10%, greater than or equal to about 12%, greater than or equal to about, greater than or equal to about 15%, greater than or equal to about 20%, greater than or equal to about 25%, or greater than or equal to about 30% by weight, e.g., based on the weight of the total dry solids of the non-woven web. In some instances, the total weight percentage of the binder components in the non-woven web may be less than or equal to about 70%, less than or equal to about 60%, less than or equal to about 50%, less than or equal to about 40%, less than or equal to about 35%, less than or equal to about 30%, less than or equal to about 28%, less than or equal to about 25%, less than or equal to about 22%, less than or equal to about 20%, less than or equal to about 15%, less than or equal to about 12%, less than or equal to about 10%, less than or equal to about 8%, less than or equal to about 5%, less than or equal to about 3%, less than or equal to about 2%, or less than or equal to about 1% by weight, e.g., based on the weight of the total dry solids of the non-woven web. Combinations of the above-referenced ranges are possible (e.g., greater than or equal to about 0.1% and less than or equal to about 40%, greater than or equal to about 0.2% and less than or equal to about 25%).

In some embodiments, the one or more binder components may impart beneficial mechanical properties to the non-woven web without adversely affecting one or more filtration properties. For instance, in some embodiments, the non-woven web may exhibit an advantageous air permeability. In some embodiments, the non-woven web may have an air permeability of greater than or equal to about 1 CFM, greater than or equal to about 5 CFM, greater than or equal to about 10 CFM, greater than or equal to about 25 CFM, greater than or equal to about 50 CFM, greater than or equal to about 75 CFM, greater than or equal to about 100 CFM, greater than or equal to about 125 CFM, greater than or equal to about 150 CFM, greater than or equal to about 175 CFM, greater than or equal to about 200 CFM, greater than or equal to about 225 CFM, greater than or equal to about 250 CFM, or greater than or equal to about 275 CFM. In some instances, the non-woven web may have an air permeability of less than or equal to about 500 CFM, less than or equal to about 420 CFM, less than or equal to about 350 CFM, less than or equal to about 300 CFM, less than or equal to about 225 CFM, less than or equal to about 200 CFM, less than or equal to about 175 CFM, less than or equal to about 150 CFM, less than or equal to about 125 CFM, less than or equal to about 100 CFM, less than or equal to about 75 CFM, or less than or equal to about 50 CFM. Combinations of the above-referenced ranges are also possible (e.g., greater than or equal to about 1 CFM and less than or equal to about 500 CFM, greater than or equal to about 5 CFM and less than or equal to about 500 CFM, greater than or equal to about 10 CFM and less than or equal to about 420 CFM). Other values of air permeability are also possible. The air permeability may be determined according to the standard TAPPI T-251 (1985) using a test area of 38 cm² and a pressure drop of 125 Pa (0.5 inches of water).

As another example, the non-woven web may have a relatively high dust holding capacity. For instance, in some embodiments, the non-woven web may have a dust holding capacity (DHC) of greater than or equal to about 5 g/m², greater than or equal to about 10 g/m², greater than or equal to about 20 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 400 g/m², greater than or equal to about 450 g/m², or greater than or equal to about 500 g/m². In some instances, the dust holding capacity may be less than or equal to about 850 g/m², less than or equal to about 750 g/m², less than or equal to about 650 g/m², less than or equal to about 500 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², less than or equal to about 50 g/m², less than or equal to about 25 g/m², or less than or equal to about 10 g/m². Combinations of the above-referenced ranges are possible (e.g., greater than or equal to about 5 g/m² and less than or equal to about 850 g/m², greater than or equal to about 10 g/m² and less than or equal to about 350 g/m²). Other values of DHC are possible. The dust holding capacity may be determined using ISO 19438 (2013).

The dust holding capacity of a non-woven web or filter media, as referred to herein, is tested based on a Multipass Filter Test following the ISO 19438 (2013) procedure (modified by testing a flat sheet sample) on a Multipass Filter Test Stand manufactured by FTI. The testing uses ISO A3 Medium test dust manufactured by PTI, Inc. at a base upstream gravimetric dust level (BUGL) of 25 mg/liter. The test fluid is Aviation Hydraulic Fluid AERO HFA MIL H-5606A manufactured by Mobil. The test is run at a face velocity of 0.06 cm/s until a terminal pressure of 1 bar (100 kPa).

In some embodiments, the pressure drop across the non-woven web may be relatively low. For instance, in some embodiments, the pressure drop across the non-woven web may less than or equal to about 150 kPa, less than or equal to about 125 kPa, less than or equal to about 100 kPa, less than or equal to about 75 kPa, less than or equal to about 60 kPa, less than or equal to about 50 kPa, less than or equal to about 40 kPa, less than or equal to about 30 kPa, less than or equal to about 20 kPa, less than or equal to about 15 kPa, less than or equal to about 10 kPa, less than or equal to about 8 kPa, or less than or equal to about 5 kPa. In some instances, the non-woven web may have a pressure drop of greater than or equal to about 0.1 kPa, greater than or equal to about 0.2 kPa, greater than or equal to about 0.5 kPa, greater than or equal to about 1 kPa, greater than or equal to about 2 kPa, greater than or equal to about 5 kPa, greater than or equal to about 10 kPa, greater than or equal to about 20 kPa, greater than or equal to about 30 kPa, greater than or equal to about 40 kPa, greater than or equal to about 50 kPa, greater than or equal to about 60 kPa, or greater than or equal to about 70 kPa. Combinations of the above-referenced ranges are also possible (e.g., greater than or equal to about 0.1 kPa and less than or equal to about 150 kPa, greater than or equal to about 0.1 kPa and less than or equal to about 100 kPa. Other values of pressure drop are also possible. The flatsheet pressure drop can be measured using the ISO 3968. The pressure drop value can measured when clean hydraulic fluid at 15 cSt with a face velocity of 0.67 cm/s is passed through the non-woven web.

As described herein, the one or more binder components may impart beneficial mechanical properties to the filter media. In some embodiments, the binder components may impart a relatively high Mullen Burst strength to the non-woven web. For instance, in some embodiments, the non-woven web may have a dry Mullen Burst strength of greater than or equal to about 1 psi, greater than or equal to about 8 psi, greater than or equal to about 10 psi, greater than or equal to about 15 psi, greater than or equal to about 20 psi, greater than or equal to about 25 psi, greater than or equal to about 30 psi, greater than or equal to about 35 psi, greater than or equal to about 40 psi, greater than or equal to about 45 psi, greater than or equal to about 50 psi, greater than or equal to about 75 psi, greater than or equal to about 100 psi, greater than or equal to about 125 psi, greater than or equal to about 150 psi, greater than or equal to about 175 psi, or greater than or equal to about 200 psi. In some instances, the dry Mullen Burst strength may be less than or equal to about 250 psi, less than or equal to about 200 psi, less than or equal to about 150 psi, less than or equal to about 100 psi, less than or equal to about 50 psi, less than or equal to about 25 psi, less than or equal to about 20 psi, or less than or equal to about 15 psi. Combinations of the above-referenced ranges are also possible (e.g., greater than or equal to about 8 psi and less than or equal to about 100 psi). Other values of dry Mullen Burst strength are also possible. Mullen burst strength may be determined according to TAPPI T403 (1997).

In some embodiments, the binder components may impart a relatively high stiffness to the non-woven web. For instance, in some embodiments, the non-woven web may have a Gurley stiffness in the cross direction of greater than or equal to about 500 mg, greater than or equal to about 800 mg, greater than or equal to about 1,000 mg, greater than or equal to about 1,500 mg, greater than or equal to about 2,000 mg, greater than or equal to about 2,500 mg, greater than or equal to about 3,000 mg, greater than or equal to about 4,000 mg, greater than or equal to about 5,000 mg, greater than or equal to about 8,000 mg, greater than or equal to about 10,000 mg, greater than or equal to about 15,000 mg, greater than or equal to about 20,000 mg, or greater than or equal to about 30,000 mg. In some embodiments, the non-woven web may have a Gurley stiffness in the cross direction of less than or equal to about 50,000 mg, less than or equal to about 40,000 mg, less than or equal to about 35,000 mg, less than or equal to about 30,000 mg, less than or equal to about 25,000 mg, less than or equal to about 20,000 mg, less than or equal to about 15,000 mg, 10,000 mg, less than or equal to about 8,000 mg, less than or equal to about 5,000 mg, less than or equal to about 2,500 mg, or less than or equal to about 1,000 mg. All suitable combinations of the above-referenced ranges are also possible (e.g., greater than or equal to about 500 mg and less than or equal to about 50,000 mg, greater than or equal to about 800 mg and less than or equal to about 2,500 mg, greater than or equal to about 1000 mg and less than or equal to about 30,000 mg). The stiffness may be determined using the Gurley stiffness (bending resistance) recorded in units of mg (equivalent to gu) in accordance with TAPPI T543 om-94 (1994).

In some embodiments, the non-woven web may have a dry tensile strength in the cross direction of greater than or equal to about 1 lb/in, greater than or equal to about 2 lb/in, greater than or equal to about 3 lb/in, greater than or equal to about 5 lb/in, greater than or equal to about 10 lb/in, greater than or equal to about 15 lb/in, greater than or equal to about 25 lb/in, greater than or equal to about 50 lb/in, greater than or equal to about 75 lb/in, or greater than or equal to about 100 lb/in. In some instances, the dry tensile strength in the cross direction may be less than or equal to about 150 lb/in, less than or equal to about 125 lb/in, less than or equal to about 100 lb/in, less than or equal to about 75 lb/in, less than or equal to about 60 lb/in, less than or equal to about 45 lb/in, or less than or equal to about 30 lb/in. or less than or equal to about 15 lb/in. Combinations of the above-referenced ranges are also possible (e.g., greater than or equal to about 1 lb/in and less than or equal to about 150 lb/in, greater than or equal to about 2 lb/in and less than or equal to about 75 lb/in). Other values of dry tensile strength in the cross direction are also possible. The dry tensile strength in the cross direction may be determined according to the standard T494 om-96 (1996) using a jaw separation speed of 1 in/min.

In some embodiments, the non-woven web may have a dry tensile strength in the machine direction of greater than or equal to about 1 lb/in, greater than or equal to about 2 lb/in, greater than or equal to about 3 lb/in, greater than or equal to about 5 lb/in, greater than or equal to about 10 lb/in, greater than or equal to about 15 lb/in, greater than or equal to about 25 lb/in, greater than or equal to about 50 lb/in, greater than or equal to about 75 lb/in, or greater than or equal to about 100 lb/in. In some instances, the dry tensile strength in the machine direction may be less than or equal to about 150 lb/in, less than or equal to about 125 lb/in, less than or equal to about 100 lb/in, less than or equal to about 75 lb/in, less than or equal to about 60 lb/in, less than or equal to about 45 lb/in, or less than or equal to about 30 lb/in. or less than or equal to about 15 lb/in. Combinations of the above-referenced ranges are also possible (e.g., greater than or equal to about 1 lb/in and less than or equal to about 150 lb/in, greater than or equal to about 2 lb/in and less than or equal to about 75 lb/in). Other values of dry tensile strength in the machine direction are also possible. The dry tensile strength in the machine direction may be determined according to the standard T494 om-96 (1996) using a jaw separation speed of 1 in/min.

In some embodiments, the non-woven web may have a dry tensile elongation in the cross direction of greater than or equal to about 1%, greater than or equal to about 2%, greater than or equal to about 3%, greater than or equal to about 5%, greater than or equal to about 7%, greater than or equal to about 9%, greater than or equal to about 11%, greater than or equal to about 13%, or greater than or equal to about 15%. In some instances, the dry tensile elongation in the cross direction may be less than or equal to about 30%, less than or equal to about 20%, less than or equal to about 18%, less than or equal to about 15%, less than or equal to about 13%, less than or equal to about 11%, less than or equal to about 9%, less than or equal to about 7%, less than or equal to about 5%, or less than or equal to about 3%. Combinations of the above-referenced ranges are also possible (e.g., greater than or equal to about 1% and less than or equal to about 30%, greater than or equal to about 1% and less than or equal to 20%, greater than or equal to about 2% and less than or equal to about 13%). Other values of dry tensile elongation in the cross direction are also possible. The dry tensile elongation in the cross direction may be determined according to the standard T494 om-96 (1996) using a test span of 4 in and a jaw separation speed of 12 in/min.

In some embodiments, the non-woven web may have a dry tensile elongation in the machine direction of greater than or equal to about 1%, greater than or equal to about 2%, greater than or equal to about 3%, greater than or equal to about 5%, greater than or equal to about 7%, greater than or equal to about 9%, greater than or equal to about 11%, greater than or equal to about 13%, or greater than or equal to about 15%. In some instances, the dry tensile elongation in the machine direction may be less than or equal to about 30%, less than or equal to about 20%, less than or equal to about 18%, less than or equal to about 15%, less than or equal to about 13%, less than or equal to about 11%, less than or equal to about 9%, less than or equal to about 7%, less than or equal to about 5%, or less than or equal to about 3%. Combinations of the above-referenced ranges are also possible (e.g., greater than or equal to about 1% and less than or equal to about 30%, greater than or equal to about 1% and less than or equal to 20%, greater than or equal to about 2% and less than or equal to about 13%). Other values of dry tensile elongation in the machine direction are also possible. The dry tensile elongation in the machine direction may be determined according to the standard T494 om-96 (1996) using a test span of 4 in and a jaw separation speed of 12 in/min.

In some embodiments, the binder components may impart durability to the non-woven web and/or the filter media. For instance, in certain embodiments, the binder components may impart strength (e.g., Mullen burst strength) to the non-woven web and/or filter media during and after filtration, e.g., in a hot hydraulic fluid or lubricating oil. For example, the non-woven web and/or filter media have a relatively high strength even after being subjected to a hot hydraulic fluid or lubricating oil (e.g., synthetic oil) for a prolonged period of time. The increased strength of the non-woven web may be attributed, at least in part, by the inclusion of binder components (e.g., binder particles and binder fibers) in the non-woven web. In certain embodiments, a non-woven web includes one or more of the above-noted ranges, or a combination of the above-noted ranges, for Mullen burst strength after the non-woven web has been subjected to a sealed vessel, no exclusion of air, hot oil test at a temperature of at least 160° C. for at least 500 hours. In general, the hot oil test may be performed as follows. An Ofite 316 stainless steel old-style aging cell with a 500 mL capacity vessel is charged with 400 mL of Mobil 1, 5W-30 weight, advanced full synthetic oil. The vessel is sealed, such that air is not able to enter or exit the vessel. At least 4 non-woven web samples with a dimension of 2″×3½″ are added to the vessel. The vessel is sealed and placed in an oven held that is held at 160° C. for at least 500 hours. The vessel is removed from the oven and allowed to cool down to room temperature prior to opening. Samples are removed from the vessel, excess oil is blotted off, and the samples are immersed in heptane to remove oil residue from the surface. Samples are then allowed to condition for at least 12 hours at 22° C. at a relative humidity of 31-35% prior to Mullen burst strength testing.

In general, the non-woven web may have an advantageous mean flow pore size. For instance, in some embodiments, the non-woven web may have a mean flow pore size of greater than or equal to about 0.4 μm, greater than or equal to about 0.5 μm, greater than or equal to 0.9 μm, greater than or equal to about 1 μm, greater than or equal to about 10 μm, greater than or equal to about 25 μm, greater than or equal to about 50 μm greater than or equal to about 75 μm, greater than or equal to about 100 μm. In some instances, the non-woven web may have a mean flow pore size of less than or equal to about 150 μm, less than or equal to about 125 μm, less than or equal to about 100 μm, less than or equal to about 75 μm, less than or equal to about 50 less than or equal to about 25 μm, less than or equal to about 10 μm or less than or equal to about 1 μm. Combinations of the above-referenced ranges are also possible (e.g., greater than or equal to about 0.4 μm and less than or equal to about 150 μm, greater than or equal to about 0.9 μm and less than or equal to about 100 μm). Other values of mean flow pore size are also possible. The mean flow pore size may be determined according to the standard ASTM F316 (2003).

In some embodiments, the non-woven web is relatively thin (i.e. the non-woven web has a relatively small thickness). In some embodiments, the thickness of the non-woven web may be less than or equal to about 10 mm, less than or equal to about 9 mm, less than about 8 mm, less than or equal to about 7 mm, less than or equal to about 6 mm, less than or equal to about 5 mm, less than or equal to about 4 mm, less than or equal to about 3 mm, less than or equal to about 2 mm, or less than or equal to about 1 mm. In some instances, the thickness of the filter media may be greater than or equal to about 0.1 mm, greater than or equal to about 0.2 mm, greater than or equal to about 0.3 mm, greater than or equal to about 0.3 mm, greater than or equal to about 0.4 mm, greater than or equal to about 0.5 mm, greater than or equal to about 0.8 mm, greater than or equal to about 1 mm, greater than or equal to about 2 mm, greater than or equal to about 3 mm, greater than or equal to about 4 mm, or greater than or equal to about 5 mm. Combinations of the above-referenced ranges are possible (e.g., greater than or equal to about 0.1 mm and less than or equal to about 10 mm, greater than or equal to about 0.2 mm and less than or equal to about 3 mm). The thickness may be determined according to the standard ISO 534 (2011) at 2 N/cm².

In some embodiments, the non-woven web may have a basis weight of greater than or equal to about 5 g/m², greater than or equal to about 10 g/m², greater than or equal to about 25 g/m², greater than or equal to about 30 g/m², greater than or equal to about 50 g/m², greater than or equal to about 100 g/m², greater than or equal to about 150 g/m², greater than or equal to about 200 g/m², greater than or equal to about 300 g/m², greater than or equal to about 400 g/m², greater than or equal to about 500 g/m², greater than or equal to about 600 g/m², or greater than or equal to about 700 g/m². In some instances, the non-woven web may have a basis weight of less than or equal to about 850 g/m², less than or equal to about 750 g/m², less than or equal to about 600 g/m², less than or equal to about 500 g/m², less than or equal to about 400 g/m², less than or equal to about 300 g/m², less than or equal to about 250 g/m², less than or equal to about 200 g/m², less than or equal to about 100 g/m², less than or equal to about 75 g/m², or less than or equal to about 50 g/m². Combinations of the above-referenced ranges are possible (e.g., greater than or equal to about 5 g/m² and less than or equal to about 850 g/m², greater than or equal to about 10 g/m² and less than or equal to about 600 g/m², greater than or equal to about 30 g/m² and less than or equal to about 250 g/m²). Other values of basis weight are possible. The basis weight may be determined according to the standard ISO 536 (2012).

As noted above, the filter media may include a second layer. In some embodiments, the second layer functions to enhance the efficiency (e.g., particulate efficiency, fluid separation efficiency) of the filter media, and may be referred to as an efficiency layer. In some embodiments, the non-woven web may support the second layer. In some such embodiments, the second layer may not require a separate support structure (e.g., support layer, scrim layer) apart from the non-woven web. In some embodiments, the air permeability and/or mean flow pore size of the second layer may be less than the air permeability and/or mean flow pore size of the non-woven web.

In some embodiments, the second layer may have an air permeability of greater than or equal to about 0.2 CFM, greater than or equal to about 0.3 CFM, greater than or equal to about 0.5 CFM, greater than or equal to about 0.8 CFM, greater than or equal to about 1 CFM, greater than or equal to about 5 CFM, greater than or equal to about 10 CFM, greater than or equal to about 25 CFM, or greater than or equal to about 50 CFM. In some instances, the second layer may have an air permeability of less than or equal to about 150 CFM, less than or equal to about 125 CFM, less than or equal to about 100 CFM, less than or equal to about 75 CFM, or less than or equal to about 50 CFM. Combinations of the above-referenced ranges are also possible (e.g., greater than or equal to about 0.2 CFM and less than or equal to about 150 CFM, greater than or equal to about 0.2 CFM and less than or equal to about 100 CFM). Other values of air permeability are also possible.

In some embodiments, the second layer may have a mean flow pore size of greater than or equal to about 0.1 μm, greater than or equal to about 0.2 μm, greater than or equal to about 0.4 μm, greater than or equal to about 0.5 μm, greater than or equal to 0.9 μm, greater than or equal to about 1 μm, greater than or equal to about 10 μm, greater than or equal to about 25 μm, greater than or equal to about 50 μm greater than or equal to about 75 μm, greater than or equal to about 100 μm. In some instances, the second layer may have a mean flow pore size of less than or equal to about 150 μm, less than or equal to about 125 μm, less than or equal to about 100 μm, less than or equal to about 75 μm, less than or equal to about 50 μm, less than or equal to about 25 μm, less than or equal to about 10 μm or less than or equal to about 1 Combinations of the above-referenced ranges are also possible (e.g., greater than or equal to about 0.1 μm and less than or equal to about 150 μm, greater than or equal to about 0.2 μm and less than or equal to about 100 μm). Other values of mean flow pore size are also possible.

In some embodiments, the pressure drop across the second layer may be relatively low. For instance, in some embodiments, the pressure drop across the second layer may be less than or equal to about 80 kPa, less than or equal to about 70 kPa, less than or equal to about 60 kPa, less than or equal to about 50 kPa, less than or equal to about 40 kPa, less than or equal to about 30 kPa, less than or equal to about 20 kPa, less than or equal to about 15 kPa, less than or equal to about 10 kPa, less than or equal to about 8 kPa, or less than or equal to about 5 kPa. In some instances, the second layer may have a pressure drop of greater than or equal to about 0.2 kPa, greater than or equal to about 0.5 kPa, greater than or equal to about 1 kPa, greater than or equal to about 2 kPa, greater than or equal to about 5 kPa, greater than or equal to about 10 kPa, greater than or equal to about 20 kPa, or greater than or equal to about 30 kPa, greater than or equal to about 40 kPa, greater than or equal to about 50 kPa, or greater than or equal to about 60 kPa. Combinations of the above-referenced ranges are also possible (e.g., greater than or equal to about 0.2 kPa and less than or equal to about 80 kPa, greater than or equal to about 0.2 kPa and less than or equal to about 50 kPa. Other values of pressure drop are also possible.

In some embodiments, the second layer of the filter media is relatively thin (i.e. the second layer is a non-woven web having a relatively small thickness). In some embodiments, the thickness of the second layer may be less than or equal to about 10 mm, less than or equal to about 9 mm, less than about 8 mm, less than or equal to about 7 mm, less than or equal to about 6 mm, less than or equal to about 5 mm, less than or equal to about 4 mm, less than or equal to about 3 mm, less than or equal to about 2 mm, less than or equal to about 1 mm, less than or equal to 0.8 mm, less than or equal to about 0.5 mm, less than or equal to about 0.3 mm, less than or equal to about 0.2 mm, less than or equal to about 100 μm, less than or equal to about 75 μm, less than or equal to about 50 μm, less than or equal to about 35 μm, less than or equal to about 20 μm, less than or equal to about 10 μm, less than or equal to about 8 μm, less than or equal to about 5 μm, less than or equal to about 3 μm, less than or equal to about 2 μm, or less than or equal to about 1 μm. In some instances, the thickness of the filter media may be greater than or equal to about 500 nm, greater than or equal to about 600 nm, greater than or equal to about 800 nm, greater than or equal to about 1 μm, greater than or equal to about 2 μm, greater than or equal to about 3 μm, greater than or equal to about 5 μm, greater than or equal to about 10 μm, greater than or equal to about 20 μm, greater than or equal to about 35 μm, greater than or equal to about 50 μm, greater than or equal to about 75 μm, greater than or equal to about 0.1 mm, greater than or equal to about 0.2 mm, greater than or equal to about 0.3 mm, greater than or equal to about 0.3 mm, greater than or equal to about 0.4 mm, greater than or equal to about 0.5 mm, greater than or equal to about 0.8 mm, greater than or equal to about 1 mm, greater than or equal to about 2 mm, greater than or equal to about 3 mm, greater than or equal to about 4 mm, or greater than or equal to about 5 mm. Combinations of the above-referenced ranges are possible (e.g., greater than or equal to about 500 nm and less than or equal to about 10 mm, greater than or equal to about 0.1 mm and less than or equal to about 3 mm). Thicknesses of 1 micron or greater may be determined according to the standard ISO 534 (2011) at 2 N/cm². Thicknesses less than 1 micron may be determined using scanning electron microscopy.

In some embodiments, the second layer of the filter media may have a basis weight of greater than or equal to about 0.1 g/m², greater than or equal to about 0.2 g/m², greater than or equal to about 0.5 g/m², greater than or equal to about 0.8 g/m², greater than or equal to about 1 g/m², greater than or equal to about 2 g/m², greater than or equal to about 5 g/m², greater than or equal to about 10 g/m², greater than or equal to about 15 g/m², greater than or equal to about 20 g/m², greater than or equal to about 50 g/m², greater than or equal to about 75 g/m², greater than or equal to about 100 g/m², greater than or equal to about 150 g/m², or greater than or equal to about 200 g/m². In some instances, the second layer of the filter media may have a basis weight of less than or equal to about 500 g/m², less than or equal to about 400 g/m², less than or equal to about 300 g/m², less than or equal to about 250 g/m², less than or equal to about 200 g/m², less than or equal to about 150 g/m², less than or equal to about 100 g/m², less than or equal to about 50 g/m², less than or equal to about 25 g/m², or less than or equal to about 10 g/m². Combinations of the above-referenced ranges are possible (e.g., greater than or equal to about 0.1 g/m² and less than or equal to about 500 g/m², greater than or equal to about 0.1 g/m² and less than or equal to about 300 g/m²). Other values of basis weight are possible. The basis weight may be determined according to the standard ISO 536 (2012).

In some embodiments, the second layer may comprise one or more binders components described herein with respect to the non-woven web. For instance, in some embodiments, the second layer may comprise binder fibers and/or binder particles as described herein. For example, the second layer may comprise binder particles. In some instances, the second layer may comprise binder fibers. In certain embodiments, the second layer may comprise binder fibers and binder particles. In some embodiments, one or more binder components in the second layer may differ from a binder component in the non-woven web. In certain embodiments, one or more binder components in the second layer may be the same as a binder component in the non-woven web. In some embodiments, a second layer comprising binder components may have substantially similar or the same mechanical properties (e.g., stiffness, dry Mullen Burst strength, tensile strength, tensile elongation, hot oil Mullen Burst strength) as the non-woven web without compromising one or more filtration properties of the second layer. In other embodiments, the mechanical properties may be different.

It should be understood that in embodiments in which the second layer comprises one or more binder components, the binder components in the second layer may fall within the ranges and/or have the properties described herein with respect to binder components in the non-woven web unless specified otherwise below. Further, in embodiments in which the second layer comprises one or more binder components, the mechanical properties, including stiffness, dry Mullen Burst strength, tensile strength, tensile elongation, and hot oil Mullen Burst strength, fall within the ranges described above with respect to the mechanical properties of the non-woven web.

As described herein, the non-woven web may impart beneficial mechanical properties to the filter media. In some embodiments, the non-woven may impart sufficient stiffness to the filter media to allow the media to be self-supporting and/or pleatable without the need for additional support structures (e.g., a support layer, backer, mesh, glue beads). As used herein, the term “self-supporting” with respect to a filter media refers to the ability of a filter media to maintain its shape (e.g., maintain its pleated shape, as described in more detail below) following exposure to elevated temperatures. The self-supporting property of the filter media may be determined by heating the filter media to a temperature of 200° C. for 1 minute, followed by placing the filter media on a flat surface (at room temperature and ambient pressure) and visually inspecting the filter media to determine whether the filter media maintains its shape, or whether the filter media deforms (e.g., folds or bends) under its own weight. If the filter media maintains its shape under its own weight (e.g., if it maintains its pleated shape) without deformation, then the filter media is considered to be self-supporting. In some embodiments, the filter media is self-supporting even in cases in which the filter media does not comprise support structures such as scrim layers, glue beads, mesh, or backers. In certain cases, the filter media becomes self-supporting following a treatment, such as a curing treatment (e.g., to melt and/or cure one or more binder components).

In some embodiments, the filter media may have a dry Mullen Burst strength of greater than or equal to about 5 psi, greater than or equal to about 10 psi, greater than or equal to about 15 psi, greater than or equal to about 20 psi, greater than or equal to about 25 psi, greater than or equal to about 30 psi, greater than or equal to about 40 psi, greater than or equal to about 50 psi, greater than or equal to about 60 psi, greater than or equal to about 75 psi, or greater than or equal to about 100 psi. In some instances, the dry Mullen Burst strength may be less than or equal to about 500 psi, less than or equal to about 350 psi, less than or equal to about 250 psi, less than or equal to about 150 psi, less than or equal to about 100 psi, or less than or equal to about 50 psi. Combinations of the above-referenced ranges are also possible (e.g., greater than or equal to about 5 psi and less than or equal to about 500 psi). Other values of dry Mullen Burst strength are also possible.

In some embodiments, the filter media includes one or more of the above-noted ranges, or a combination of the above-noted ranges, for Mullen burst strength after the filter media has been subjected to a sealed vessel, no exclusion of air, hot oil test at a temperature of at least 160° C. for at least 500 hours, as described above with respect to the non-woven web.

The filter media may have a relatively high stiffness. For instance, in some embodiments, the filter media may have a Gurley stiffness in the cross direction of greater than or equal to about 500 mg, greater than or equal to about 750 mg, greater than or equal to about 1,000 mg, greater than or equal to about 1,500 mg, greater than or equal to about 2,000 mg, greater than or equal to about 2,500 mg, greater than or equal to about 3,000 mg, greater than or equal to about 4,000 mg, greater than or equal to about 5,000 mg, greater than or equal to about 8,000 mg, greater than or equal to about 10,000 mg, greater than or equal to about 15,000 mg, greater than or equal to about 20,000 mg, or greater than or equal to about 30,000 mg. In some embodiments, the filter media may have a Gurley stiffness in the cross direction of less than or equal to about 50,000 mg, less than or equal to about 40,000 mg, less than or equal to about 35,000 mg, less than or equal to about 30,000 mg, less than or equal to about 25,000 mg, less than or equal to about 20,000 mg, less than or equal to about 15,000 mg, less than or equal to about 10,000 mg, less than or equal to about 8,000 mg, less than or equal to about 6,500 mg, less than or equal to about 5,000 mg, less than or equal to about 2,000 mg, or less than or equal to about 1,000 mg. All suitable combinations of the above-referenced ranges are also possible (e.g., greater than or equal to about 500 mg and less than or equal to about 50,000 mg, greater than or equal to about 4,000 mg and less than or equal to about 6,500 mg, greater than or equal to about 1,000 mg and less than or equal to about 30,000 mg). The stiffness may be determined using the Gurley stiffness (bending resistance) recorded in units of mm (equivalent to gu) in accordance with TAPPI T543 om-94 (1994).

The filter media may have a relatively high compression resistance. In some cases, the relatively high compression resistance may be due, at least in part to, the presence of one or more binder components. For instance, in some embodiments, the filter media may have a compression resistance greater than or equal to about 0.01 g, greater than or equal to about 0.1 g, greater than or equal to about 1 g, greater than or equal to about 10 g, greater than or equal to about 25 g, greater than or equal to about 50 g, greater than or equal to about 100 g, greater than or equal to about 250 g, greater than or equal to about 500 g, greater than or equal to about 1,000 g, greater than or equal to about 2,500 g, greater than or equal to about 5,000 g, greater than or equal to about 7,500 g, greater than or equal to about 10,000 g, greater than or equal to about 25,000 g, greater than or equal to about 50,000 g, or greater than or equal to about 75,000 g. In some embodiments, the filter media may have a compression resistance of less than or equal to about 100,000 g, less than or equal to about 75,000 g, less than or equal to about 50,000 g, less than or equal to about 25,000 g, less than or equal to about 10,000 g, less than or equal to about 7,500 g, less than or equal to about 5,000 g, less than or equal to about 2,500 g, less than or equal to about 1,000 g, less than or equal to about 500 g, less than or equal to about 250 g, less than or equal to about 100 g, or less than or equal to about 50 g. All suitable combinations of the above-referenced ranges are also possible (e.g., greater than or equal to about 0.1 g and less than or equal to about 100,000 g, greater than or equal to about 500 g and less than or equal to about 50,000 g). The compression resistance may be determined as follows. A filter media sample that is 3 cm wide and 2 inches long is pleated to form two peaks (i.e., into an M shape). The pleats have a height of 0.5 inches and a spacing of 1 cm. The pleated filter media sample is then heated for 1 minute at 150 □C. If the pleat height of the sample changes by 10% or more as a result of heating (e.g., due to curling or wrinkling), the sample is not accepted and the compression resistance is recorded as 0 g. The bottom of the sample is then immobilized on a substrate having grooves 1 cm apart, such that each sample edge and peak valley is positioned within a groove. The grooves serve to immobilize the sample and maintain the 1 cm peak spacing. A foot having a diameter of 3 cm is placed on top of the peaks. A load is placed on the foot. The load is increased at a rate of 15 g/sec. The test is stopped when a load is added that causes the pleat height of the sample to become less than 20% of the starting pleat height. The load required to reduce the pleat height to less than 20% of the starting pleat height % is recorded as the compression resistance.

In some embodiments, the filter media may have a dry tensile strength in the cross direction of greater than or equal to about 1 lb/in, greater than or equal to about 2 lb/in, greater than or equal to about 3 lb/in, greater than or equal to about 5 lb/in, greater than or equal to about 10 lb/in, greater than or equal to about 15 lb/in, greater than or equal to about 25 lb/in, greater than or equal to about 50 lb/in, greater than or equal to about 75 lb/in, or greater than or equal to about 100 lb/in. In some instances, the dry tensile strength in the cross direction may be less than or equal to about 150 lb/in, less than or equal to about 125 lb/in, less than or equal to about 100 lb/in, less than or equal to about 75 lb/in, less than or equal to about 60 lb/in, less than or equal to about 45 lb/in, or less than or equal to about 30 lb/in. or less than or equal to about 15 lb/in. Combinations of the above-referenced ranges are also possible (e.g., greater than or equal to about 1 lb/in and less than or equal to about 150 lb/in, greater than or equal to about 2 lb/in and less than or equal to about 75 lb/in). Other values of dry tensile strength in the cross direction are also possible. The dry tensile strength in the cross direction may be determined according to the standard T494 om-96 (1996) using a jaw separation speed of 1 in/min.

In some embodiments, the filter media may have a dry tensile strength in the machine direction of greater than or equal to about 1 lb/in, greater than or equal to about 2 lb/in, greater than or equal to about 3 lb/in, greater than or equal to about 5 lb/in, greater than or equal to about 10 lb/in, greater than or equal to about 15 lb/in, greater than or equal to about 25 lb/in, greater than or equal to about 50 lb/in, greater than or equal to about 75 lb/in, or greater than or equal to about 100 lb/in. In some instances, the dry tensile strength in the machine direction may be less than or equal to about 150 lb/in, less than or equal to about 125 lb/in, less than or equal to about 100 lb/in, less than or equal to about 75 lb/in, less than or equal to about 60 lb/in, less than or equal to about 45 lb/in, or less than or equal to about 30 lb/in. or less than or equal to about 15 lb/in. Combinations of the above-referenced ranges are also possible (e.g., greater than or equal to about 1 lb/in and less than or equal to about 150 lb/in, greater than or equal to about 2 lb/in and less than or equal to about 75 lb/in). Other values of dry tensile strength in the machine direction are also possible. The dry tensile strength in the machine direction may be determined according to the standard T494 om-96 (1996) using a jaw separation speed of 1 in/min.

In some embodiments, the filter media may have a dry tensile elongation in the cross direction of greater than or equal to about 1%, greater than or equal to about 2%, greater than or equal to about 3%, greater than or equal to about 5%, greater than or equal to about 7%, greater than or equal to about 9%, greater than or equal to about 11%, greater than or equal to about 13%, or greater than or equal to about 15%. In some instances, the dry tensile elongation in the cross direction may be less than or equal to about 20%, less than or equal to about 18%, less than or equal to about 15%, less than or equal to about 13%, less than or equal to about 11%, less than or equal to about 9%, less than or equal to about 7%, less than or equal to about 5%, or less than or equal to about 3%. Combinations of the above-referenced ranges are also possible (e.g., greater than or equal to about 1% and less than or equal to about 20%, greater than or equal to about 2% and less than or equal to about 13%). Other values of dry tensile elongation in the cross direction are also possible. The dry tensile elongation in the cross direction may be determined according to the standard T494 om-96 (1996) using a test span of 4 in and a jaw separation speed of 12 in/min.

In some embodiments, the filter media may have a dry tensile elongation in the machine direction of greater than or equal to about 1%, greater than or equal to about 2%, greater than or equal to about 3%, greater than or equal to about 5%, greater than or equal to about 7%, greater than or equal to about 9%, greater than or equal to about 11%, greater than or equal to about 13%, or greater than or equal to about 15%. In some instances, the dry tensile elongation in the machine direction may be less than or equal to about 20%, less than or equal to about 18%, less than or equal to about 15%, less than or equal to about 13%, less than or equal to about 11%, less than or equal to about 9%, less than or equal to about 7%, less than or equal to about 5%, or less than or equal to about 3%. Combinations of the above-referenced ranges are also possible (e.g., greater than or equal to about 1% and less than or equal to about 20%, greater than or equal to about 2% and less than or equal to about 13%). Other values of dry tensile elongation in the machine direction are also possible. The dry tensile elongation in the machine direction may be determined according to the standard T494 om-96 (1996) using a test span of 4 in and a jaw separation speed of 12 in/min.

In some embodiments, the filter media may have a dust holding capacity (DHC) of greater than or equal to about 5 g/m², greater than or equal to about 8 g/m², greater than or equal to about 10 g/m², greater than or equal to about 20 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 400 g/m², greater than or equal to about 450 g/m², or greater than or equal to about 500 g/m². In some instances, the dust holding capacity may be less than or equal to about 1000 g/m², less than or equal to about 800 g/m², less than or equal to about 700 g/m², less than or equal to about 600 g/m², less than or equal to about 550 g/m², less than or equal to about 500 g/m², less than or equal to about 450 g/m², less than or equal to about 400 g/m², less than or equal to about 350 g/m², less than or equal to about 300 g/m², less than or equal to about 200 g/m², or less than or equal to about 100 g/m². Combinations of the above-referenced ranges are possible (e.g., greater than or equal to about 5 g/m² and less than or equal to about 1000 g/m², greater than or equal to about 10 g/m² and less than or equal to about 500 g/m²). Other values of DHC are possible.

The non-woven webs and filter media described herein may be used for the filtration of various particle sizes. The efficiency of the filter media for capturing particles having a particle size, x (μm) or greater can be measured. In a typical test for measuring efficiency of a layer or the entire media (e.g., according to the standard ISO 19438 (2013)), particle counts at the particle size, x, selected (e.g., where x is 1, 3, 4, 5, 7, 10, 15, 20, 25, or 30 μm) upstream and downstream of the layer or media can be taken at certain points over the time of the test. Generally, a particle size of x means that x μm or greater particles will be captured by the layer or media. The average of upstream and downstream particle counts can be taken at the selected particle size. From the average particle count upstream (injected −C₀) and the average particle count downstream (passed thru −C) the filtration efficiency test value for the particle size selected can be determined by the relationship [(1−[C/C₀])*100%].

As described herein, efficiency can be measured according to standard ISO 19438 (2013). The testing uses ISO12103-A3 Medium grade test dust at a base upstream gravimetric dust level (BUGL) of 50 mg/liter. The test fluid is Aviation Hydraulic Fluid AERO HFA MIL H-5606A manufactured by Mobil. The test is run at a face velocity of 0.06 cm/s until a terminal pressure of 100 kPa. Unless otherwise stated, the dust holding capacity values and/or average efficiency values described herein are determined at a terminal pressure of 100 kPa. The average efficiency is the average of the efficiency values measured at one minute intervals until the terminal pressure is reached. A similar protocol can be used for measuring initial efficiency, which refers to the average efficiency measurements of the media at 4, 5, and 6 minutes after running the test. Unless otherwise indicated, average efficiency and initial efficiency measurements described herein refer to values where x=4 μm.

The filter media described herein may have a wide range of initial efficiencies (e.g., liquid filtration efficiencies). In some embodiments, a filter media has an initial efficiency of between about 5% and about 100%. The initial efficiency may be, for example, greater than or equal to about 5%, greater than or equal to about 8%, greater than or equal to about 10%, greater than or equal to about 20%, greater than or equal to about 35%, greater than or equal to about 50%, greater than or equal to about 65%, greater than or equal to about 80%, greater than or equal to about 90%, greater than or equal to about 95%, greater than or equal to about 97%, or greater than or equal to about 99%. The initial efficiency may be less than or equal to about 100%, less than or equal to about 99%, less than or equal to about 97%, less than or equal to about 95%, less than or equal to about 90%, less than or equal to about 80%, less than or equal to about 65%, less than or equal to about 50%, less than or equal to about 35%, or less than or equal to about 20%. Such initial efficiencies may be achieved for filtering particles of different sizes such as particles of 10 μm or greater, particles of 8 μm or greater, particles of 6 μm or greater, particles of 5 μm or greater, particles of 4 μm or greater, particles of 3 μm or greater, particles of 2 μm or greater, or particles of 1 μm or greater. Other particle sizes and efficiencies are also possible. All suitable combinations of particle sizes and initial efficiencies are possible (e.g., an initial efficiency of greater than or equal to about 5% and less than or equal to about 100% for filtering particles of 4 μm or greater).

The filter media described herein may have a wide range of average efficiencies (e.g., liquid filtration efficiencies). In some embodiments, a filter media has an average efficiency of between about 5% and about 100%. The average efficiency may be, for example, greater than or equal to about 5%, greater than or equal to about 8%, greater than or equal to about 10%, greater than or equal to about 20%, greater than or equal to about 35%, greater than or equal to about 50%, greater than or equal to about 65%, greater than or equal to about 80%, greater than or equal to about 90%, greater than or equal to about 95%, greater than or equal to about 97%, or greater than or equal to about 99%. The average efficiency may be less than or equal to about 100%, less than or equal to about 99%, less than or equal to about 97%, less than or equal to about 95%, less than or equal to about 90%, less than or equal to about 80%, less than or equal to about 65%, less than or equal to about 50%, less than or equal to about 35%, or less than or equal to about 20%. Such average efficiencies may be achieved for filtering particles of different sizes such as particles of 10 μm or greater, particles of 8 μm or greater, particles of 6 μm or greater, particles of 5 μm or greater, particles of 4 μm or greater, particles of 3 μm or greater, particles of 2 μm or greater, or particles of 1 μm or greater. Other particle sizes and efficiencies are also possible. All suitable combinations of particle sizes and average efficiencies are possible (e.g., an average efficiency of greater than or equal to about 5% and less than or equal to about 100% for filtering particles of 4 μm or greater).

In some embodiments, the filter media may exhibit an advantageous air permeability. In some embodiments, the filter media may have an air permeability of greater than or equal to about 0.3 CFM, greater than or equal to about 0.5 CFM, greater than or equal to about 0.8 CFM, greater than or equal to about 1 CFM, greater than or equal to about 5 CFM, greater than or equal to about 10 CFM, greater than or equal to about 25 CFM, greater than or equal to about 50 CFM, greater than or equal to about 75 CFM, greater than or equal to about 100 CFM, greater than or equal to about 125 CFM, greater than or equal to about 150 CFM, greater than or equal to about 175 CFM, greater than or equal to about 200 CFM, greater than or equal to about 225 CFM, greater than or equal to about 250 CFM, or greater than or equal to about 275 CFM. In some instances, the filter media may have an air permeability of less than or equal to about 500 CFM, less than or equal to about 420 CFM, less than or equal to about 350 CFM, less than or equal to about 300 CFM, less than or equal to about 225 CFM, less than or equal to about 200 CFM, less than or equal to about 175 CFM, less than or equal to about 150 CFM, less than or equal to about 125 CFM, less than or equal to about 100 CFM, less than or equal to about 75 CFM, or less than or equal to about 50 CFM. Combinations of the above-referenced ranges are also possible (e.g., greater than or equal to about 0.3 CFM and less than or equal to about 500 CFM, greater than or equal to about 0.3 CFM and less than or equal to about 300 CFM). Other values of air permeability are also possible.

In some embodiments, the filter media may have a mean flow pore size of greater than or equal to about 0.2 μm, greater than or equal to about 0.4 μm, greater than or equal to about 0.5 μm, greater than or equal to 0.9 μm, greater than or equal to about 1 μm, greater than or equal to about 10 μm, greater than or equal to about 25 μm, greater than or equal to about 50 μm greater than or equal to about 75 μm, greater than or equal to about 100 μm. In some instances, the non-woven web may have a mean flow pore size of less than or equal to about 200 μm, less than or equal to about 150 μm, less than or equal to about 125 μm, less than or equal to about 100 μm, less than or equal to about 75 μm, less than or equal to about 50 μm, less than or equal to about 25 μm, less than or equal to about 10 μm or less than or equal to about 1 μm. Combinations of the above-referenced ranges are also possible (e.g., greater than or equal to about 0.2 μm and less than or equal to about 200 μm, greater than or equal to about 0.2 μm and less than or equal to about 100 μm). Other values of mean flow pore size are also possible.

In some embodiments, the pressure drop across the filter media (e.g. across the entire filter media) may be relatively low. For instance, in some embodiments, the pressure drop across the filter media may less than or equal to about 300 kPa, less than or equal to about 250 kPa, less than or equal to about 200 kPa, less than or equal to about 150 kPa, less than or equal to about 100 kPa, less than or equal to about 75 kPa, less than or equal to about 50 kPa, less than or equal to about 30 kPa, less than or equal to about 20 kPa. In some instances, the filter media may have a pressure drop of greater than or equal to about 0.1 kPa, greater than or equal to about 0.2 kPa, greater than or equal to about 0.5 kPa, greater than or equal to about 1 kPa, greater than or equal to about 2 kPa, greater than or equal to about 5 kPa, greater than or equal to about 10 kPa, greater than or equal to about 20 kPa, greater than or equal to about 30 kPa, greater than or equal to about 40 kPa, greater than or equal to about 50 kPa, greater than or equal to about 60 kPa, greater than or equal to about 70 kPa, greater than or equal to about 90 kPa, or greater than or equal to about 100 kPa. Combinations of the above-referenced ranges are also possible (e.g., greater than or equal to about 0.1 kPa and less than or equal to about 300 kPa, greater than or equal to about 0.3 kPa and less than or equal to about 100 kPa. Other values of pressure drop are also possible.

In some embodiments, the filter media is relatively thin (i.e. the filter media has a relatively small thickness). In some embodiments, the thickness of the filter media may be less than or equal to about 10 mm, less than or equal to about 9 mm, less than about 8 mm, less than or equal to about 7 mm, less than or equal to about 6 mm, less than or equal to about 5 mm, less than or equal to about 4 mm, less than or equal to about 3 mm, less than or equal to about 2 mm, or less than or equal to about 1 mm. In some instances, the thickness of the filter media may be greater than or equal to about 0.1 mm, greater than or equal to about 0.2 mm, greater than or equal to about 0.3 mm, greater than or equal to about 0.3 mm, greater than or equal to about 0.4 mm, greater than or equal to about 0.5 mm, greater than or equal to about 0.8 mm, greater than or equal to about 1 mm, greater than or equal to about 2 mm, greater than or equal to about 3 mm, greater than or equal to about 4 mm, or greater than or equal to about 5 mm. Combinations of the above-referenced ranges are possible (e.g., greater than or equal to about 0.1 mm and less than or equal to about 10 mm, greater than or equal to about 0.3 mm and less than or equal to about 5 mm). The thickness may be determined according to the standard ISO 534 (2011) at 2 N/cm².

In some embodiments, the filter media may have a basis weight of greater than or equal to about 10 g/m², greater than or equal to about 15 g/m², greater than or equal to about 25 g/m², greater than or equal to about 50 g/m², greater than or equal to about 100 g/m², greater than or equal to about 150 g/m², greater than or equal to about 200 g/m², greater than or equal to about 300 g/m², greater than or equal to about 400 g/m², greater than or equal to about 500 g/m², greater than or equal to about 600 g/m², or greater than or equal to about 700 g/m², greater than or equal to about 800 g/m², or greater than or equal to about 900 g/m². In some instances, the filter media may have a basis weight of less than or equal to about 1200 g/m², less than or equal to about 1100 g/m², less than or equal to about 1000 g/m², less than or equal to about 900 g/m², less than or equal to about 800 g/m², less than or equal to about 700 g/m², less than or equal to about 600 g/m², less than or equal to about 500 g/m², less than or equal to about 400 g/m², less than or equal to about 300 g/m², less than or equal to about 200 g/m², less than or equal to about 100 g/m², or less than or equal to about 50 g/m². Combinations of the above-referenced ranges are possible (e.g., greater than or equal to about 10 g/m² and less than or equal to about 1200 g/m², greater than or equal to about 10 g/m² and less than or equal to about 900 g/m²). Other values of basis weight are possible. The basis weight may be determined according to the standard ISO 536 (2012).

In some embodiments, one or more layers (e.g., non-woven web, second layer) of the filter media and/or the filter media may be designed to have beneficial filtration properties, such as fluid separation efficiency (e.g., fuel-water separation efficiency). In some embodiments in which the filter media is used for fluid separation, the surface(s) and/or interior of one or more layers may be modified to be repelling toward the fluid to be separated. For instance, the repelling surface may substantially block the transport of droplets of the fluid to be separated, such that droplets of a certain size may be inhibited from flowing across the layer having the repelling surface and are separated (e.g., shed) from the filtration fluid. In other embodiments, the surface(s) and/or interior of one or more layers may be modified to be wetting toward the fluid to be separated. In some such embodiments, the wetting surface and/or interior may be used to cause at least a portion of droplets of the fluid to be separated to coalesce, such that the droplets have the requisite size for removal at a subsequent layer and/or such that the coalesced droplets are able to be separated (e.g., via gravity) at the wetting portion of the layer (e.g., surface, interior).

As used herein, the terms “wet” and “wetting” refer to the ability of a fluid to interact with a surface such that the contact angle of the fluid with respect to the surface is less than 90 degrees. Accordingly the terms “repel” and “repelling” refer to the ability of a fluid to interact with a surface such that the contact angle of the fluid with respect to the surface is greater than or equal to 90 degrees.

In some embodiments, the surface and/or interior of one or more layers may be modified to repel the fluid to be separated. In some such embodiments, one or more layers (e.g., a surface(s) and/or interior of a layer) may be modified to alter the wettability of at least a portion of the layer (e.g., at least one surface of a layer) with respect to a particular fluid (e.g., to make a layer more hydrophobic). For example, a hydrophobic surface having a water contact angle of 100° may be modified to have a water contact angle of greater than 100°, such as 130° or greater. In some embodiments, the modification (e.g., surface modification) may alter the hydrophilicity or hydrophobicity of at least a portion of the layer (e.g., one surface of the layer), such that the layer has the opposite hydrophilicity or hydrophobicity, respectively. For example, a relatively hydrophilic layer may be modified with a hydrophobic material, such that the modified portion (e.g., surface(s) and/or interior, entire layer) is hydrophobic. In some embodiments, the layer may have one modified surface (e.g., upstream surface) and one unmodified surface (e.g., downstream surface). In other embodiments, the layer may have two or more modified surfaces (e.g., the upstream and downstream surfaces). In some embodiments, the entire layer and/or filter media may be modified. For example, the interior and the surfaces of one or more layers and/or the entire filter media may be modified.

In some embodiments, one or more layers (e.g., non-woven web, second layer) and/or filter media may be modified with a water repellent. The water repellent may serve to increase the water contact angle of one or more layers (e.g., non-woven web, second layer) and/or the filter media. Non-limiting examples of water-repellents include paraffin repellents, fluorocarbons, fluorocarbon block polymers, silicones, dendrimers, perfluorinated repellents, stearic-acid-melamine repellents, silanes, stearates, rosin, water repellants comprising an aldehyde, and sizing agents. In some embodiments, the water repellent may not comprise a silicone.

In some embodiments, one or more layers (e.g., modified layer) and/or filter media may have a water contact angle of greater than or equal to about 30 degrees, greater than or equal to about 35 degrees, greater than or equal to about 40 degrees, greater than or equal to about 50 degrees, greater than or equal to about 60 degrees, greater than or equal to about 70 degrees, greater than or equal to about 80 degrees, greater than 90 degrees, greater than or equal to 100 degrees, greater than or equal to 105 degrees, greater than or equal to 110 degrees, greater than or equal to 115 degrees, greater than or equal to 120 degrees, greater than or equal to 125 degrees, greater than or equal to 130 degrees, greater than or equal to 135 degrees, greater than or equal to 145 degrees, greater than or equal to 150 degrees, greater than or equal to 155 degrees, or greater than or equal to 160 degrees. In some instances, the water contact angle is less than or equal to about 165 degrees, less than or equal to about 160 degrees, less than or equal to about 150 degrees, less than or equal to about 140 degrees, less than or equal to about 130 degrees, less than or equal to about 120 degrees, less than or equal to about 110 degrees, less than or equal to about 100 degrees, less than or equal to about 90 degrees, less than or equal to about 80 degrees, less than or equal to about 70 degrees, less than or equal to about 60 degrees, less than or equal to about 50 degrees, less than or equal to about 40 degrees, or less than or equal to about 35 degrees. Combinations of the above-referenced ranges are also possible (e.g., greater than or equal to about 30 degrees and less than or equal to about 165 degrees, greater than or equal to about 90 degrees and less than or equal to about 165 degrees, greater than or equal to about 100 degrees and less than or equal to about 165 degrees).

In some embodiments, the weight percentage of water repellent in one or more layers (e.g., non-woven web, second layer) and/or the filter media may be greater than or equal to about 0%, greater than or equal to about 0.1%, greater than or equal to about 0.2%, greater than or equal to 0.3%, greater than or equal to about 0.5%, greater than or equal to about 0.8%, greater than or equal to about 1%, greater than or equal to about 2%, or greater than or equal to about 3%, based on the weight of the total dry solids of the one or more layers and/or the filter media (including any resins and/or binder particles). In some instances, the weight percentage of the water repellent may be less than or equal to about 5%, less than or equal to about 2%, or less than or equal to about 1% by weight, e.g., based on the weight of the total dry solids of the one or more layers and/or the filter media (including any resins and/or binder particles). Combinations of the above-referenced ranges are possible (e.g., greater than or equal to about 0% and less than or equal to about 50%, greater than or equal to about 0.3% and less than or equal to about 20%).

In general, one or more layers (e.g., non-woven web, a second layer) and/or the filter media may comprise any suitable non-binder fibers. In some embodiments, the non-binder fibers in a layer and/or the filter media may have a different glass transition temperature and/or melting temperature than one or more binder components (e.g., all binder components). For instance, in some embodiments, the glass transition temperature of non-binder fibers in one or more layers (e.g., non-woven web, a second layer) and/or the filter media may be at least about 5° C., at least about 10° C., at least about 15° C., at least about 20° C., at least about 25° C., at least about 30° C., at least about 40° C., or at least about 50° C. greater than the glass transition temperature of one or more binder components (e.g., all binder components).

In some embodiments, the glass transition temperature of non-binder fibers in one or more layers (e.g., non-woven web, a second layer) and/or the filter media may be greater than or equal to about 70° C., greater than or equal to about 80° C., greater than or equal to about 90° C., greater than or equal to about 100° C., greater than or equal to about 115° C., greater than or equal to about 130° C., or greater than or equal to about 145° C. In some instances, the glass transition temperature may be less than or equal to about 200° C., less than or equal to about 175° C., less than or equal to about 160° C., less than or equal to about 145° C., less than or equal to about 115° C., or less than or equal to about 100° C. Combinations of the above-referenced ranges are also possible (e.g., greater than or equal to about 70° C. and less than or equal to about 175° C.). Other values of glass transition temperature of the non-binder fibers in one or more layers (e.g., non-woven web, a second layer) and/or the filter media are also possible.

In some embodiments, the melting temperature of non-binder fibers in one or more layers (e.g., non-woven web, a second layer) and/or the filter media is greater than the melting temperature of one or more binder components (e.g., all binder components). For instance, in some embodiments, the melting temperature of non-binder fibers in one or more layers (e.g., non-woven web, a second layer) and/or the filter media may be at least about 5° C., at least about 10° C., at least about 15° C., at least about 20° C., at least about 25° C., at least about 30° C., at least about 40° C., at least 50° C., at least about 60° C., at least about 75° C., at least about 100° C., at least about 150° C., at least about 200° C., or by at least about 250° C. greater than the melting temperature of one or more binder components (e.g., all binder components).

In some embodiments, the non-binder fibers in one or more layers (e.g., non-woven web, a second layer) and/or the filter media may have a melting temperature of greater than or equal to about 100° C., greater than or equal to about 110° C., greater than or equal to about 120° C., greater than or equal to about 110° C., greater than or equal to about 130° C., greater than or equal to about 140° C., greater than or equal to about 150° C., greater than or equal to about 165° C., greater than or equal to about 180° C., or greater than or equal to about 200° C., greater than or equal to about 255° C., greater than or equal to about 260° C., greater than or equal to about 275° C., or greater than or equal to about 300° C. In some embodiments, the non-binder fibers in one or more layers (e.g., non-woven web, a second layer) and/or the filter media may have a melting temperature of less than or equal to 1,500° C., less than or equal to 1,250° C., less than or equal to 1100° C., less than or equal to 1,000° C., less than or equal to 800° C., less than or equal to 700° C., less than an or equal to 600° C., less than or equal to 500° C., less than or equal to 400° C., or less than or equal to 350° C. It should be understood that all combinations of the above-referenced ranges are possible (e.g., greater than or equal to about 100° C. and less than or equal to about 1,500° C.).

In some embodiments, the non-binder fibers in one or more layers (e.g., non-woven web, a second layer) and/or the filter media may comprise synthetic fibers. Synthetic fibers may include any suitable type of synthetic polymer. Examples of suitable synthetic fibers include polyesters (e.g., polyethylene terephthalate, polybutylene terephthalate), polycarbonate, polyamides (e.g., various nylon polymers), polyaramid, polyimide, polyethylene, polypropylene, polyether ketone, polyolefin, acrylics/polyacrylics, polymethyl methacrylate, polystyrene, polyaniline, polyethylene imide, polyvinyl alcohol, cellulose acetate, regenerated cellulose (e.g., synthetic cellulose such Lyocell, rayon, acrylic), polyacrylonitriles, polysulfones, polyvinylidene fluoride (PVDF), copolymers of polyethylene and PVDF, copolymers of polypropylene and PVDF, polyphenylene ether sulfones, polyether sulfones, and combinations thereof. In some embodiments, the synthetic fibers are organic polymer fibers. In some embodiments, the synthetic fibers are in the form of continuous fibers. The non-binder fibers may also include combinations of more than one type of synthetic fiber. It should be understood that other types of synthetic fiber types may also be used. In certain embodiments, the fiber types described above may apply to the synthetic fibers of the overall media (e.g., the overall media may comprise one or more of the synthetic fibers described above).

In some embodiments, the average diameter of the synthetic fibers of one or more layers (e.g., non-woven web, second layer) and/or filter media may be, for example, greater than or equal to about 0.1 microns, greater than or equal to about 0.3 microns, greater than or equal to about 0.5 microns, greater than or equal to about 1 micron, greater than or equal to about 2 microns, greater than or equal to about 3 microns, greater than or equal to about 4 microns, greater than or equal to about 5 microns, greater than or equal to about 8 microns, greater than or equal to about 10 microns, greater than or equal to about 12 microns, greater than or equal to about 15 microns, or greater than or equal to about 20 microns. In some instances, the synthetic fibers may have an average diameter of less than or equal to about 30 microns, less than or equal to about 20 microns, less than or equal to about 15 microns, less than or equal to about 10 microns, less than or equal to about 7 microns, less than or equal to about 5 microns, less than or equal to about 4 microns, less than or equal to about 1.5 microns, less than or equal to about 1 micron, less than or equal to about 0.8 microns, or less than or equal to about 0.5 microns. Combinations of the above-referenced ranges are also possible (e.g., greater than or equal to about 1 micron and less than or equal to about 5 microns). Other values of average fiber diameter are also possible.

In some embodiments, the synthetic fibers are not continuous (e.g., staple fibers). For instance, in some embodiments, synthetic fibers in one or more layers in the filter media may have an average length of greater than or equal to about 0.025 mm, greater than or equal to about 0.05 mm, greater than or equal to about 0.5 mm, greater than or equal to about 1 mm, greater than or equal to about 2 mm, greater than or equal to about 4 mm, greater than or equal to about 6 mm, greater than or equal to about 8 mm, greater than or equal to about 10 mm, greater than or equal to about 12 mm, or greater than or equal to about 15 mm. In some instances, synthetic fibers may have an average length of less than or equal to about 25 mm, less than or equal to about 20 mm, less than or equal to about 15 mm, less than or equal to about 12 mm, less than or equal to about 10 mm, less than or equal to about 8 mm, less than or equal to about 6 mm, less than or equal to about 4 mm, less than or equal to about 2 mm, less than or equal to about 1 mm, or less than or equal to about 0.5 mm. Combinations of the above-referenced ranges are also possible (e.g., greater than or equal to about 1 mm and less than or equal to about 4 mm). Other values of average fiber length are also possible. In certain embodiments, the ranges of average fiber length described above may apply to the synthetic fibers of the overall media.

In some cases, the synthetic fibers may be continuous (e.g., meltblown fibers, meltspun fibers, spunbond fibers, electrospun fibers, centrifugal spun fibers, etc.). For instance, synthetic fibers may have an average length of greater than or equal to about 1 inch, greater than or equal to about 50 inches, greater than or equal to about 100 inches, greater than or equal to about 300 inches, greater than or equal to about 500 inches, greater than or equal to about 700 inches, or greater than or equal to about 900 inches. In some instances, synthetic fibers may have an average length of less than or equal to about 1000 inches, less than or equal to about 800 inches, less than or equal to about 600 inches, less than or equal to about 400 inches, or less than or equal to about 100 inches. Combinations of the above-referenced ranges are also possible (e.g., greater than or equal to about 50 inches and less than or equal to about 1000 inches). Other values of average fiber length are also possible.

In some embodiments, the weight percentage of synthetic fibers in one or more layers (e.g., non-woven web, second layer) and/or filter media may be relatively high. For instance, in some embodiments, the weight percentage of synthetic fibers in one or more layers may be greater than or equal to about 0.5 wt %, greater than or equal to about 1 wt %, greater than or equal to about 2 wt %, greater than or equal to about 20 wt %, greater than or equal to about 40 wt %, greater than or equal to about 60 wt %, greater than or equal to about 80 wt %, greater than or equal to about 90 wt %, or greater than or equal to about 95 wt %. In some instances, the weight percentage of synthetic fibers in one or more layers and/or the entire filter media may be less than or equal to about 100 wt %, less than or equal to about 98 wt %, less than or equal to about 85 wt %, less than or equal to about 75 wt %, less than or equal to about 50 wt %, less than or equal to about 25 wt %, less than or equal to about 10 wt %, or less than or equal to about 5 wt %. Combinations of the above-referenced ranges are also possible (e.g., greater than or equal to about 2 wt % and less than or equal to about 100 wt %). Other values of weight percentage of synthetic fibers in one or more and/or the entire filter media are also possible. In some embodiments, the layer includes 100 wt % synthetic fibers. In some embodiments, a layer or the filter media includes the above-noted ranges of synthetic fibers with respect to the total weight of fibers in a layer or filter media, respectively. In some embodiments, the above weight percentages are based on the weight of the total dry solids of a layer or filter media (including any resins).

In some embodiments, the non-binder fibers in one or more layers (e.g., non-woven web, a second layer) and/or the filter media may comprise fibrillated fibers. As known to those of ordinary skill in the art, a fibrillated fiber includes a parent fiber that branches into smaller diameter fibrils, which can, in some instances, branch further out into even smaller diameter fibrils with further branching also being possible. The branched nature of the fibrils leads to a high surface area and can increase the number of contact points between the fibrillated fibers and the fibers in the fiber web. Such an increase in points of contact between the fibrillated fibers and other fibers and/or components of the web may contribute to enhancing mechanical properties (e.g., flexibility, strength) and/or filtration performance properties of the fiber web.

Examples of fibrillated fibers, include, but are not limited to, fibrillated regenerated cellulose (e.g., rayon, Lyocell), microfibrillated cellulose, nanofibrillated cellulose, fibrillated synthetic fibers, including nanofibrillated synthetic fibers (e.g., fibrillated fibers formed of synthetic polymers such as polyester, polyamide, polyaramid, para-aramid, meta-aramid, polyimide, polyethylene, polypropylene, polyether ether ketone, polyethylene terephthalate, polyolefin, nylon, and/or acrylics), and fibrillated natural fibers (e.g., hardwood, softwood). Regardless of the type of fibrillated fibers, the weight percentage of fibrillated fibers in one or more layers (e.g., non-woven web, second layer) and/or the entire filter media may be greater than or equal to about 0 wt %, greater than or equal to about 1 wt %, greater than or equal to about 5 wt %, greater than or equal to about 10 wt %, greater than or equal to about 20 wt %, greater than or equal to about 30 wt %, greater than or equal to about 40 wt %, greater than or equal to about 50 wt %, greater than or equal to about 60 wt %, greater than or equal to about 70 wt %, or greater than or equal to about 80 wt %, e.g., based on the total weight of fibers in the layer or media. In some instances, the weight percentage of the fibrillated fibers in one or more layers and/or the entire filter media may be less than or equal to about 100 wt %, less than or equal to about 98 wt %, less than or equal to about 95 wt %, less than or equal to about 90 wt %, less than or equal to about 80 wt %, less than or equal to about 70 wt %, less than or equal to about 60 wt %, less than or equal to about 50 wt %, less than or equal to about 40 wt %, less than or equal to about 30 wt %, less than or equal to about 20 wt %, or less than or equal to about 10%, e.g., based on the total weight of fibers in the layer or media. Combinations of the above-referenced ranges are also possible (e.g., greater than or equal to about 0 wt %, and less than or equal to about 100 wt %, greater than or equal to about 0 wt %, and less than or equal to about 80 wt %). Other values of weight percentage of the fibrillated fibers in one or more layers and/or the entire filter media are also possible. In some embodiments, a layer or the filter media may include 0 wt % fibrillated fibers. In some embodiments, a layer (e.g., non-woven web, second layer) or the filter media may include greater than or equal to about 90 wt. % (e.g., 100 wt. %) fibrillated fibers. For instance, the second layer may comprise 100 wt. % fibrillated fibers. In some embodiments, a layer or the filter media includes the above-noted ranges of fibrillated fibers with respect to the total weight of fibers in the layer or filter media, respectively. In some embodiments, the above weight percentages are based on the weight of the total dry solids of the layer or filter media (including any resins).

In some embodiments the parent fibers may have an average diameter in the micron range. For example, the parent fibers may have an average diameter of greater than or equal to about 1 micron, greater than or equal to about 5 microns, greater than or equal to about 10 microns, greater than or equal to about 20 microns, greater than or equal to about 30 microns, greater than or equal to about 40 microns, greater than or equal to about 50 microns, greater than or equal to about 60 microns, or greater than or equal to about 70 microns. In some embodiments, the parent fibers may have an average diameter of less than or equal to about 75 microns, less than or equal to about 55 microns, less than or equal to about 35 microns, less than or equal to about 25 microns, less than or equal to about 15 microns, less than or equal to about 10 microns, or less than or equal to about 5 microns. Combinations of the above referenced ranges are also possible (e.g., parent fibers having an average diameter of greater than or equal to about 1 micron and less than or equal to about 25 microns). Other ranges are also possible.

In other embodiments, the parent fibers may have an average diameter in the nanometer range. For instance in, some embodiments, the parent fibers may have an average diameter of less than about 1 micron, less than or equal to about 0.8 microns, less than or equal to about 0.5 microns, less than or equal to about 0.1 microns, less than or equal to about 0.05 microns, less than or equal to about 0.02 microns, less than or equal to about 0.01 microns, or less than or equal to about 0.005 microns. In some embodiments, the parent fibers may have an average diameter of greater than or equal to about 0.003 microns, greater than or equal to about 0.004 micron, greater than or equal to about 0.01 microns, greater than or equal to about 0.05 microns, greater than or equal to about 0.1 microns, or greater than or equal to about 0.5 microns. Combinations of the above referenced ranges are also possible (e.g., parent fibers having an average diameter of greater than or equal to about 0.004 microns and less than about or equal to about 0.02 microns). Other ranges are also possible.

The average diameter of the fibrils is generally less than the average diameter of the parent fibers. Depending on the average diameter of the parent fibers, in some embodiments, the fibrils may have an average diameter of less than or equal to about 25 microns, less than or equal to about 20 microns, less than or equal to about 10 microns, less than or equal to about 5 microns, less than or equal to about 1 micron, less than or equal to about 0.5 microns, less than or equal to about 0.1 microns, less than or equal to about 0.05 microns, or less than or equal to about 0.01 microns. In some embodiments the fibrils may have an average diameter of greater than or equal to about 0.003 microns, greater than or equal to about 0.01 micron, greater than or equal to about 0.05 microns, greater than or equal to about 0.1 microns, greater than or equal to about 0.5 microns greater than or equal to about 1 micron, greater than or equal to about 5 microns, greater than or equal to about 10 microns, or greater than or equal to about 20 microns. Combinations of the above referenced ranges are also possible (e.g., fibrils having an average diameter of greater than or equal to about 0.01 microns and less than or equal to about 20 microns). Other ranges are also possible.

The level of fibrillation may be measured according to any number of suitable methods. For example, the level of fibrillation of the fibrillated fibers can be measured according to a Canadian Standard Freeness (CSF) test, specified by TAPPI test method T 227 om 09 (2009) Freeness of pulp. The test can provide an average CSF value.

In some embodiments, the average CSF value of the fibrillated fibers used in one or more layers may vary between about 5 mL and about 750 mL. In certain embodiments, the average CSF value of the fibrillated fibers used one or more layers may be greater than or equal to 1 mL, greater than or equal to about 10 mL, greater than or equal to about 20 mL, greater than or equal to about 35 mL, greater than or equal to about 45 mL, greater than or equal to about 50 mL, greater than or equal to about 65 mL, greater than or equal to about 70 mL, greater than or equal to about 75 mL, greater than or equal to about 80 mL, greater than or equal to about 100 mL, greater than or equal to about 150 mL, greater than or equal to about 175 mL, greater than or equal to about 200 mL, greater than or equal to about 250 mL, greater than or equal to about 300 mL, greater than or equal to about 350 mL, greater than or equal to about 500 mL, greater than or equal to about 600 mL, greater than or equal to about 650 mL, greater than or equal to about 700 mL, or greater than or equal to about 750 mL.

In some embodiments, the average CSF value of the fibrillated fibers used in one or more layers may be less than or equal to about 800 mL, less than or equal to about 750 mL, less than or equal to about 700 mL, less than or equal to about 650 mL, less than or equal to about 600 mL, less than or equal to about 550 mL, less than or equal to about 500 mL, less than or equal to about 450 mL, less than or equal to about 400 mL, less than or equal to about 350 mL, less than or equal to about 300 mL, less than or equal to about 250 mL, less than or equal to about 225 mL, less than or equal to about 200 mL, less than or equal to about 150 mL, less than or equal to about 100 mL, less than or equal to about 90 mL, less than or equal to about 85 mL, less than or equal to about 70 mL, less than or equal to about 50 mL, less than or equal to about 40 mL, less than or equal to about 25 mL, less than or equal to about 10 mL, or less than or equal to about 5 mL. Combinations of the above-referenced ranges are also possible (e.g., greater than or equal to about 10 mL and less than or equal to about 300 mL). Other ranges are also possible. The average CSF value of the fibrillated fibers used in one or more layers may be based on one type of fibrillated fiber or more than one type of fibrillated fiber.

In some embodiments, the non-binder fibers in one or more layers (e.g., non-woven web, a second layer) and/or the filter media may include one or more cellulose fibers, such as softwood fibers, hardwood fibers, a mixture of hardwood and softwood fibers, regenerated cellulose fibers (e.g., rayon, fibrillated synthetic cellulose fibers such as Lyocell fibers), microfibrillated cellulose, and mechanical pulp fibers (e.g., groundwood, chemically treated mechanical pulps, and thermomechanical pulps). Exemplary softwood fibers include fibers obtained from mercerized southern pine (e.g., mercerized southern pine fibers or “HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), or chemically treated mechanical pulps (“CTMP fibers”). For example, HPZ fibers can be obtained from Buckeye Technologies, Inc., Memphis, Tenn.; Robur Flash fibers can be obtained from Rottneros AB, Stockholm, Sweden; and Brunswick pine fibers can be obtained from Georgia-Pacific, Atlanta, Ga. Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, Conn. (“Westvaco fibers”), and (6) Georgia-Pacific, Atlanta, Ga. (“Leaf River fibers”).

The average diameter of the cellulose fibers in one or more layers (e.g., non-woven web, a second layer) and/or the entire filter media may be, for example, greater than or equal to about 1 micron, greater than or equal to about 2 microns, greater than or equal to about 3 microns, greater than or equal to about 4 microns, greater than or equal to about 5 microns, greater than or equal to about 8 microns, greater than or equal to about 10 microns, greater than or equal to about 15 microns, greater than or equal to about 20 microns, greater than or equal to about 30 microns, or greater than or equal to about 40 microns. In some instances, the cellulose fibers may have an average diameter of less than or equal to about 50 microns, less than or equal to about 40 microns, less than or equal to about 30 microns, less than or equal to about 20 microns, less than or equal to about 15 microns, less than or equal to about 10 microns, less than or equal to about 7 microns, less than or equal to about 5 microns, less than or equal to about 4 microns, or less than or equal to about 2 microns. Combinations of the above-referenced ranges are also possible (e.g., greater than or equal to about 1 micron and less than or equal to about 5 microns). Other values of average fiber diameter are also possible.

In some embodiments, the cellulose fibers may have an average length. For instance, in some embodiments, cellulose fibers may have an average length of greater than or equal to about 0.5 mm, greater than or equal to about 1 mm, greater than or equal to about 2 mm, greater than or equal to about 3 mm, greater than or equal to about 4 mm, greater than or equal to about 5 mm, greater than or equal to about 6 mm, or greater than or equal to about 8 mm. In some instances, cellulose fibers may have an average length of less than or equal to about 10 mm, less than or equal to about 8 mm, less than or equal to about 6 mm, less than or equal to about 4 mm, less than or equal to about 2 mm, or less than or equal to about 1 mm. Combinations of the above-referenced ranges are also possible (e.g., greater than or equal to about 1 mm and less than or equal to about 3 mm). Other values of average fiber length are also possible.

Regardless of the type of cellulose fibers, in some embodiments, the weight percentage of cellulose fibers in one or more layers (e.g., non-woven web, a second layer) and/or the entire filter media may be greater than or equal to about 0 wt %, greater than or equal to about 5 wt %, greater than or equal to about 10 wt %, greater than or equal to about 15 wt %, greater than or equal to about 45 wt %, greater than or equal to about 65 wt %, or greater than or equal to about 90 wt %, e.g., based on the total weight of fibers in the layer or media. In some instances, the weight percentage of the cellulose fibers in one or more layers and/or the entire filter media may be less than or equal to about 100 wt %, less than or equal to about 85 wt %, less than or equal to about 55 wt %, less than or equal to about 20 wt %, less than or equal to about 10 wt %, or less than or equal to about 2 wt %, e.g., based on the total weight of fibers in the layer or media. Combinations of the above-referenced ranges are also possible (e.g., greater than or equal to about 0 wt % and less than or equal to about 100 wt %). Other values of weight percentage of the cellulose fibers in one or more layers are also possible. In some embodiments, one or more layers (e.g., second layer) and/or the entire filter media include 100 wt % cellulose fibers. In other embodiments, one or more layers (e.g., non-woven web) and/or the entire filter media include 0 wt % cellulose fibers. In some embodiments, a layer or media includes the above-noted ranges of cellulose fibers with respect to the total weight of fibers in the layer or media, respectively. In some embodiments, the above weight percentages are based on the weight of the total dry solids of the layer (including any resins).

In some embodiments, one or more layers (e.g., non-woven web, a second layer) and/or the entire filter media is substantially free of glass fibers (e.g., less than 1 wt % glass fibers, between about 0 wt % and about 1 wt % glass fibers). For instance, the non-woven web, second layer, and/or the entire filter media may include 0 wt % glass fibers. Filter media and arrangements that are substantially free of glass fibers may be advantageous for certain applications (e.g., fuel-water separation, particulate separation in fuel systems), since glass fibers may shed and leach sodium ions (e.g., Na⁺) which can lead to physical abrasion and soap formation. For example, shedding of glass fibers may lead to the blockage of fuel injectors such as in high pressure common rail applications. In other embodiments, the second layer may optionally include glass fibers (e.g., microglass and/or chopped glass fibers).

In other embodiments, however, one or more layers and/or the entire filter media in the filter media may include glass fibers (e.g., microglass fibers, chopped strand glass fibers, or a combination thereof). The average diameter of glass fibers may be, for example, less than or equal to about 30 microns, less than or equal to about 25 microns, less than or equal to about 15 microns, less than or equal to about 12 microns, less than or equal to about 10 microns, less than or equal to about 9 microns, less than or equal to about 7 microns, less than or equal to about 5 microns, less than or equal to about 3 microns, or less than or equal to about 1 micron. In some instances, the glass fibers may have an average fiber diameter of greater than or equal to about 0.1 microns, greater than or equal to about 0.3 microns, greater than or equal to about 1 micron, greater than or equal to about 3 microns, or greater than equal to about 7 microns greater than or equal to about 9 microns, greater than or equal to about 11 microns, or greater than or equal to about 20 microns. Combinations of the above-referenced ranges are also possible (e.g., greater than or equal to about 0.1 microns and less than or equal to about 9 microns). Other values of average fiber diameter are also possible.

In some embodiments, the weight percentage of the glass fibers may be greater than or equal to about 0 wt %, greater than or equal to about 2 wt %, greater than or equal to about 5 wt %, greater than or equal to about 10 wt %, greater than or equal to about 15 wt %. greater than or equal to about 25 wt %, greater than or equal to about 35 wt %, greater than or equal to about 50 wt %, greater than or equal to about 65 wt %, or greater than or equal to about 80 wt %. In some instances, the weight percentage of the glass fibers in the layer may be less than or equal to about 100 wt %, less than or equal to about 98 wt %, less than or equal to about 95 wt %, less than or equal to about 90 wt %, less than or equal to about 80 wt %, less than or equal to about 65 wt %, less than or equal to about 50 wt %, less than or equal to about 35 wt %, less than or equal to about 25 wt %, less than or equal to about 20 wt %, less than or equal to about 15 wt %, less than or equal to about 10 wt %, less than or equal to about 5 wt %, less than or equal to about 2 wt %, or less than or equal to about 1 wt %. Combinations of the above-referenced ranges are also possible (e.g., greater than or equal to about 0 wt % and less than or equal to about 10 wt %, greater than or equal to about 2 wt % and less than or equal to about 100 wt %). In some embodiments, weight percentage of the glass fibers may be less than or equal to about 5 wt. % (e.g., 0 wt. %). In other embodiments, weight percentage of the glass fibers may be greater than or equal to about 90 wt. % (e.g., 100 wt. %). Other values of weight percentage of the glass in a layer are also possible. In some embodiments, a layer or the filter media includes the above-noted ranges of glass fibers with respect to the total weight of fibers in the layer or filter media, respectively. In some embodiments, the above weight percentages are based on the weight of the total dry solids of the layer.

In some embodiments, one or more layers and/or the entire filter media, in addition to a fibers and/or binder components, may also include other components, such as a resin and/or additives. In general, any suitable resin may be used to achieve the desired properties. For example, the resin may be polymeric, water-based, solvent-based, dry strength, and/or wet strength. In certain embodiments, the resin may also include additives, such as hydrophobic additives, hydrophilic additives, viscose, nanoparticles, zeolite, natural polymers (starches, gums), cellulose derivatives, such as carboxymethyl cellulose, methylcellulose, hemicelluloses, synthetic polymers such as phenolics, latexes, polyamides, polyacrylamides, urea-formaldehyde, melamine-formaldehyde, polyamides), carbon fibers, particles, activated carbon, vermiculate, perlite, silicone, surfactants, coupling agents, crosslinking agents, conductive additives, viscosity modifiers, a cross-linker, pH adjuster, and/or diamaceous earth. It should be understood that the resin may, or may not, include other components. Typically, any additional components are present in limited amounts, e.g., less than 40% by weight of the resin, less than 20% by weight of the resin, less than 10% by weight of the resin, less than 5% by weight of the resin.

In some embodiments, at least a portion of the fibers of one or more layer (e.g., non-woven web, second layer) may be coated with a resin without substantially blocking the pores of the fiber web. In some instances, substantially all of the fibers may be coated without substantially blocking the pores.

In some embodiments, the resin may be a binder resin. The binder resin is not in fiber form and is to be distinguished from the binder fibers (e.g., monocomponent fibers) described above. In general, the binder resin may have any suitable composition. For example, the binder resin may comprise a thermoplastic (e.g., acrylic, polyvinylacetate, polyester, polyamide), a thermoset (e.g., epoxy, phenolic resin), or a combination thereof. In some cases, a binder resin includes one or more of a vinyl acetate resin, an epoxy resin, a polyester resin, a copolyester resin, a polyvinyl alcohol resin, an acrylic resin such as a styrene acrylic resin, and a phenolic resin. Other resins are also possible. In some embodiments, the weight percentage of resin (e.g., binder resin) within the one or more layers and/or the filter media may be relatively low. For instance, the weight percentage of resin (e.g., binder resin) within the one or more layers and/or the filter media may be less than or equal to about 40%, less than or equal to about 20%, less than or equal to about 15%, less than or equal to about 12%, less than or equal to about 10%, less than or equal to about 8%, less than or equal to about 5%, or less than or equal to about 3% by weight, e.g., based on the weight of the total dry solids of a layer and/or the filter media.

Filter media described herein may be used in an overall filtration arrangement or filter element. In some embodiments, one or more additional layers or components are included with the filter media. Non-limiting examples of additional layers (e.g., a third layer, a fourth layer) include a meltblown layer, a wet laid layer, a spunbond layer, a carded layer, an air-laid layer, a spunlace layer, a forcespun layer, a centrifugal spun layer or an electrospun layer. In some embodiments, the additional layers may not include a support layer. In some embodiments, multiple layers, in accordance with embodiments described herein, may be layered together in forming a multi-layer sheet for use in a filter media or element.

In some embodiments two or more layers of the filter media (e.g., non-woven web and the second layer) may be formed separately, and combined by any suitable method such as lamination, collation, or by use of adhesives. The two or more layers may be formed using different processes, or the same process. For example, each of the layers may be independently formed by a wet-laid process, a non-wet laid process (e.g., meltblown process, melt spinning process, centrifugal spinning process, electrospinning process, dry laid process, air laid process), or any other suitable process. In some embodiments, one or more layers of the filter media are formed by a wet-laid process.

In some embodiments, two or more layers (e.g., non-woven web and the second layer) may be formed by the same process. In some instances, the two or more layers (e.g., layer including fine polymeric staple fiber and the second layer) may be formed simultaneously.

Different layers may be adhered together by any suitable method. For instance, layers may be adhered by an adhesive and/or melt-bonded to one another on either side. Lamination and calendering processes may also be used. In some embodiments, an additional layer may be formed from any type of fiber or blend of fibers via an added headbox or a coater and appropriately adhered to another layer.

The filter media may include any suitable number of layers, e.g., at least 2, at least 3, at least 4, at least 5, at least 6, at least 7 layers. In some embodiments, the filter media may include up to 20 layers.

Filter media described herein may be produced using suitable processes, such as using a wet-laid or a non-wet laid process. In general, a wet-laid process involves mixing together of fibers of one or more type; for example, non-binder fibers of one type may be mixed together with non-binder fibers of another type, and/or with binder fibers, to provide a fiber slurry. The slurry may be, for example, an aqueous-based slurry. In certain embodiments, fibers, are optionally stored separately, or in combination, in various holding tanks prior to being mixed together (e.g., to achieve a greater degree of uniformity in the mixture).

For instance, a first fiber may be mixed and pulped together in one container and a second fiber may be mixed and pulped in a separate container. The first fibers and the second fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture. Furthermore, it should be appreciated that other combinations of fibers types may be used in fiber mixtures, such as the fiber types described herein.

In certain embodiments, a media including two or more layers, such as the non-woven web and second layer, is formed by a wet laid process. For example, a first dispersion (e.g., a pulp) containing fibers in a solvent (e.g., an aqueous solvent such as water) can be applied onto a wire conveyor in a papermaking machine (e.g., a fourdrinier or a rotoformer) to form first layer supported by the wire conveyor. A second dispersion (e.g., another pulp) containing fibers in a solvent (e.g., an aqueous solvent such as water) is applied onto the first layer either at the same time or subsequent to deposition of the first layer on the wire. Vacuum is continuously applied to the first and second dispersions of fibers during the above process to remove the solvent from the fibers, thereby resulting in an article containing first and second layers. The article thus formed is then dried and, if necessary, further processed (e.g., calendered) by using known methods to form multi-layered filter media. In some embodiments, such a process may result in the first layer and second layer being discrete layers, as described above. However, in certain embodiments, such a process may result in the first and second layer not being discrete layers. For example, a transition layer between the first and second layers may be formed in some cases, as described above. Such a transition layer may be caused by an intermingling of fibers from the first layer and fibers from the second dispersion when the second dispersion is applied onto the first layer.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, the wet laid process uses similar equipment as in a conventional papermaking process, for example, a hydropulper, a former or a headbox, a dryer, and an optional converter. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of fiber is in a suitable range, such as for example, between about 0.1% and 0.5% by weight.

In some cases, the pH of the fiber slurry may be adjusted as desired. For instance, fibers of the slurry may be dispersed under generally neutral conditions.

Before the slurry is sent to a headbox, the slurry may optionally be passed through centrifugal cleaners and/or pressure screens for removing unfiberized material. The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, a cylinder, or an inclined wire fourdrinier. In some processes, the wet laid layer can be formed on a non-wet laid layer (e.g., scrim).

As described herein, in some embodiments, a binder particle may be added to a layer (e.g., a non-woven web, second layer). In some embodiments, the binder particles may be added to the layer via beater addition. In such a process, fibers and binder particles are added to water so as to form an aqueous slurry. The slurry may be subject to suitable agitation, for example, provided by exposing the slurry to ultrasonic energy, shaking the container in which the slurry resides, blending the slurry, subjecting the slurry to rotating blades mounted on an axle-like shaft, subjecting the slurry to a crushing mechanism, or other techniques. Such agitation may give rise to compressive or shear forces in the slurry. In some embodiments, the slurry may form a solution with multiple phases, such as an emulsion, dispersion, co-dispersion, colloid, and/or suspension. The slurry may be agitated at an appropriate temperature, such as between about 80° F. and about 150° F., or temperatures outside of this range. The slurry may be agitated for a suitable period of time so as to result in a desirable percentage of solids in a slurry, for example, between 1% and 10%. Other components may be added to the batch one after another during constant agitation. In some cases, blades may continuously rotate so as to beat the fibers and binder particles into a pulp slurry.

As described herein, in some embodiments, a resin is added to a layer (e.g., a pre-formed layer formed by a wet-laid process). For instance, as the layer is passed along an appropriate screen or wire, different components included in the resin (e.g., polymeric binder, an acid scavenger, and/or other components), which may be in the form of separate emulsions, are added to the fiber layer using a suitable technique. In some cases, each component of the resin is mixed as an emulsion prior to being combined with the other components and/or layer. The components included in the resin may be pulled through the layer using, for example, gravity and/or vacuum. In some embodiments, one or more of the components included in the resin may be diluted with softened water and pumped into the layer. In some embodiments, a resin may be applied to a fiber slurry prior to introducing the slurry into a headbox. For example, the resin may be introduced (e.g., injected) into the fiber slurry and impregnated with and/or precipitated on to the fibers. In some embodiments, a resin may be added to a layer by a solvent saturation process.

In other embodiments, a non-wet laid process (e.g., a dry laid process, an air laid process, a spinning process such as electrospinning or centrifugal spinning, a meltblown process) is used to form portions of a filter media (e.g., the second layer). For example, in certain embodiments, a layer (e.g., second layer) may be formed by a meltblowing system, such as the meltblown system described in U.S. Publication No. 2009/0120048, filed Nov. 7, 2008, and entitled “Meltblown Filter Medium”, and U.S. Publication No. 2012-0152824, filed Dec. 17, 2010, and entitled, “Fine Fiber Filter Media and Processes”, each of which is incorporated herein by reference in its entirety for all purposes. In certain embodiments, a layer (e.g., second layer) may be formed by a meltspinning or a centrifugal spinning process. In some embodiments, a non-wet laid process, such as an air laid or carding process may be used to form a layer (e.g., second layer). For example, in an air laid process, synthetic fibers may be mixed, while air is blown onto a conveyor. In a carding process, in some embodiments, the fibers are manipulated by rollers and extensions (e.g., hooks, needles) associated with the rollers. In some cases, forming the layers through a non-wet laid process may be more suitable for the production of a highly porous media. The layer may be impregnated (e.g., via saturation, spraying, etc.) with any suitable resin, as discussed above. In some embodiments, a non-wet laid process (e.g., meltblown, electrospun) may be used to form a layer (e.g., second layer) and a wet laid process may be used to form another layer (e.g., first layer). The layers may be combined using any suitable process (e.g., lamination, co-pleating, or collation).

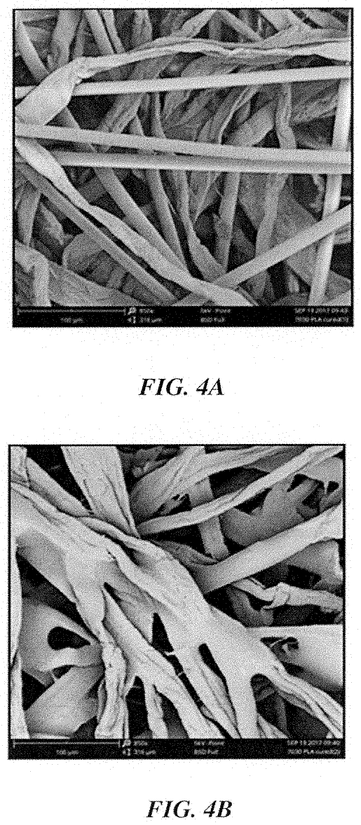

During and/or after the formation of the non-woven web or filter media described herein, the non-woven web or filter media may be exposed to an elevated temperature or otherwise heated. For example, in some embodiments, the non-woven web or filter media is placed in an environment having a relatively high temperature (e.g., an oven) for a certain period of time. Such a heating step may contribute, in part, to the joining of components of the web or filter media by one or more binder components of the non-woven web or filter media. For example, the non-woven web or filter media may be placed in an oven and heated at a temperature that causes the binder components to bond to other components and/or cure (e.g., cross-link). In some embodiments, a heating step may cause one or more binder components to undergo a minimal change in shape (e.g., cylindrical to non-cylindrical) without film formation. A non-limiting example of a heat induced change in shape without film formation can be seen in FIGS. 4A-4B. FIG. 4A shows an SEM image of a non-woven web comprising a plurality of non-binder fibers (e.g., cellulose fibers and synthetic fibers) and binder fibers before a heating step has taken place. FIG. 4B shows an SEM image of the non-woven web after a heating step, in which the binder fibers are non-cylindrical.

In some embodiments, the non-woven web and/or filter media comprising a binder component is heated at a temperature at or above the glass transition temperature and/or melting temperature of the binder component. For example, in some embodiments the non-woven web comprises a binder fiber and/or binder particle, and during and/or after formation of the non-woven web, the non-woven web is heated at a temperature at or above the glass transition temperature and/or melting temperature of the binder fiber and/or the binder particle. The non-woven web may be heated at a temperature that is equal to, at least 1° C. higher, at least 2° C. higher, at least 5° C. higher, at least 10° C. higher, at least 15° C. higher, at least 20° C. higher, at least 30° C. higher, at least 40° C. higher, at least 50° C. higher, at least 75° C. higher, or at least 100° C. higher than the glass transition temperature and/or melting temperature of a binder component contained in the non-woven web. In some cases, the non-woven web is heated at a temperature that is at or above the glass transition temperature and/or melting temperature of a binder component (e.g., a binder fiber) but below the glass transition temperature and/or melting temperature of at least one other component of the non-woven web or filter media (e.g., non-binder fibers). In some cases, the non-woven web comprises two different types of binder components, and the non-woven web is heated at a temperature that is greater than the glass transition temperature and/or melting temperature of one of the binder components (e.g., a binder fiber) and below the glass transition temperature and/or melting temperature of the other binder component (e.g., a binder particle). For example, a non-woven web may be heated at a certain temperature to soften and/or melt one binder component (e.g., a binder fiber) and cure (e.g., via cross-linking) the other binder component (e.g., a binder particle), without melting the other component. In some such cases, the other binder component has a relatively low curing temperature but a very high melting temperature.

In some embodiments, the non-woven web or filter media is heated at a temperature at or above the curing temperature of a binder component. In some cases, the non-woven web is heated at a temperature that is that is equal to, at least 1° C. higher, at least 2° C. higher, at least 5° C. higher, at least 10° C. higher, at least 15° C. higher, at least 20° C. higher, at least 30° C. higher, at least 40° C. higher, at least 50° C. higher, at least 75° C. higher, or at least 100° C. higher than the curing temperature of a binder component contained in the non-woven web.

During or after formation of a filter media, the filter media may be further processed according to a variety of known techniques. For instance, a coating method may be used to include a water repellent in the filter media. Optionally, additional layers can be formed and/or added to a filter media using processes such as lamination, co-pleating, or collation. For example, in some cases, two layers (e.g., non-woven web and the second layer) are formed into a composite article by a wet laid process as described above, and the composite article is then combined with a third layer by any suitable process (e.g., lamination, co-pleating, or collation). It can be appreciated that a filter media or a composite article formed by the processes described herein may be suitably tailored not only based on the components of each layer, but also according to the effect of using multiple layers of varying properties in appropriate combination to form filter media having the characteristics described herein.

In some embodiments, further processing may involve pleating the filter media. For instance, two layers may be joined by a co-pleating process. In some cases, the filter media, or various layers thereof, may be suitably pleated by forming score lines (e.g., longitudinally along the center line of the filter media) at appropriately spaced distances apart from one another, allowing the filter media to be folded (e.g., in a longitudinal direction) along the score lines repeatedly. As a result of the pleating, the filter media may comprise repeated bends or curves or folds, referred to herein as pleats, that distort both the top and bottom face of the filter media in a similar manner. Such pleating may increase the surface area of the filter media that is exposed to the flow of fluid in certain applications. The pleats, being repeated bends, curves, or folds, can have a certain peak-to-valley amplitude (e.g., an average amplitude). The peak-to-valley amplitude of a repeating pleated shape is readily apparent to one of skill in the art. In some cases, the filter media may be wrapped around each other around a core, or one layer can be wrapped around a pleated layer. It should be appreciated that any suitable pleating technique may be used. In some embodiments, a filter media can be post-processed such as subjected to a corrugation process to increase surface area within the web. In other embodiments, a filter media may be embossed. The filter media and/or non-woven webs described herein may maintain a pleated shape (e.g., may maintain a certain average peak-to-valley amplitude) without the presence of a support structure (e.g., a support layer, glue beads, mesh, backer layers, etc.), at least in part due to the presence of certain mechanical properties imparted by certain components, such as the presence of one or more binder components described herein.

The pleating pattern of a filter media can have any number of different shapes. For example, the pleats could be curved, follow an “accordion” pattern, have squared edges (e.g., a “box” shape), have a rounded or waved shape, or follow star-shaped or Chevron patterns. In the longitudinal direction, the pleats may be substantially straight, or undulate (e.g., form a zig-zag pattern along the longitudinal direction of each pleat fold). The tips of the pleats, (e.g., in the vicinity of the peak or valley of the pleats) can form a “V” (e.g., form a well-defined vertex), or they could be rounded (e.g., a “U” shape). The tips of the pleats could also be bulbous or have local maxima and minima (e.g., a “W” shape).

In some embodiments, the filter media includes pleats having an average peak-to-valley amplitude that is relatively large. For example, in some embodiments, the filter media includes pleats having an average-peak-to-valley amplitude of at least 1.0 mm, at least 2.0 mm, at least 3.0 mm, at least 5.0 mm, at least 8.0 mm, at least 10 mm, at least 15 mm, at least 20 mm, at least 25 mm, at least 35 mm, at least 50 mm, at least 75 mm, at least 100 mm, at least 200 mm, at least 300 mm, at least 400 mm, or at least 500 mm. In some embodiments, the filter media includes pleats having an average-peak-to-valley amplitude of less than or equal to 1.0 m, less than or equal to 0.75 m, less than or equal to 0.65 m, less than or equal to 500 mm, less than or equal to 400 mm, less than or equal to 300 mm, less than or equal to 200 mm, less than or equal to 100 mm, less than or equal to 75 mm, less than or equal to 50 mm, or less. Combinations of these ranges are possible. For example, in some embodiments, the filter media includes pleats having an average-peak-to-valley amplitude of at least 1.0 mm and less than or equal to 1.0 m, or at least 10 mm and less than or equal to 500 mm.

In certain embodiments, the filter media includes pleats having an average peak-to-valley amplitude that is large relative to the thickness of the filter media. For example, in certain embodiments, the filter media includes pleats having an average peak-to-valley amplitude that is at least 2.0 times, at least 5.0 times, at least 7.5 times, at least 10 times, at least 20 times, or at least 50 times the thickness of the filter media. In some embodiments, the filter media includes pleats having an average peak-to-valley amplitude that is less than or equal to 1000 times, less than or equal to 500 times, less than or equal to 300 times, less than or equal to 200 times, less than or equal to 100 times, less than or equal to 75 times, less than or equal to 50 times, less than or equal to 30 times, less than or equal to 20 times, less than or equal to 10 times the thickness of the filter media. Combinations of these ranges are possible. For example, in some embodiments, the filter media includes pleats have an average peak-to-valley amplitude of at least 2 times and less than or equal to 1000 times the thickness of the filter media.

It should be appreciated that the filter media may include other parts in addition to the one or more layers described herein. In some embodiments, further processing includes incorporation of one or more structural features and/or stiffening elements. For instance, the filter media may not be combined with additional structural features such as polymeric and/or metallic meshes. In one embodiment, a screen backing (e.g., expanded metal wire, extruded plastic mesh) disposed on the filter media to provide further stiffness may not be required. In some cases, the non-woven web described herein may aid in retaining the pleated configuration.

In some embodiments, a layer described herein may be a non-woven web. A non-woven web may include non-oriented fibers (e.g., a random arrangement of fibers within the web). Examples of non-woven webs include webs made by wet-laid or non-wet laid processes as described herein. Non-woven webs also include papers such as cellulose-based webs. In some embodiments, the non-woven web is a wet-laid non-woven web.

In some embodiments, filter media can be incorporated into a variety of filter elements for use in various filtering applications. Exemplary types of filters include fuel filters (e.g., automotive fuel filters), hydraulic mobile filters, hydraulic industrial filters, oil filters (e.g., lube oil filters or heavy duty lube oil filters), chemical processing filters, industrial processing filters, medical filters (e.g., filters for blood), air filters, and water filters. In some cases, filter media described herein can be used as coalescer filter media. The filter media may be suitable for filtering gases or liquids.

In some embodiments, the filter media layers may be pleated, wrapped with or without a core, wrapped around a pleated media in, e.g., a fuel water separator. In certain embodiments, a collection bowl or other suitable component may be positioned upstream, downstream, or both upstream and downstream of the media. A collection bowl is a vessel that is used to collect water after it is shed/separated/coalesced from the media. The collection bowl may be part of the filter element or filter housing.

The non-woven web and/or the filter media disclosed herein can be incorporated into a variety of filter elements for use in various applications including hydraulic and non-hydraulic filtration applications including fuel applications, lube applications, air applications, amongst others.

Filter elements can also be in any suitable form, such as pleated filter, capsules, spiral wound elements, plate and frame devices, flat sheet modules, vessel bags, disc tube units, radial filter elements, panel filter elements, or channel flow elements. A radial filter element can include pleated filter media that are constrained within two open wire meshes in a cylindrical shape. During use, fluids can flow from the outside through the pleated media to the inside of the radial element.

### EXAMPLES

The following examples are intended to illustrate certain embodiments of the present invention, but do not exemplify the full scope of the invention.

### Example 1

This example describes the mechanical and filtration properties for non-woven webs including (i) synthetic fibers and (ii) a binder particle and/or binder fiber. The non-woven webs including a binder fiber and/or a binder particle had increased Mullen Burst strength, stiffness, and air permeability compared to a non-woven web lacking a binder particle and binder fiber.

Briefly, four non-woven webs were formed using a wet-laid process. Each filter media contained polyester staple fibers having an average diameter of 1.0 microns, fibrillated acrylic staple fibers having an average tenacity of 5-7 g/den, and about 12 wt. % binder resin. Non-woven web 1 also contained 12 wt. % of solid binder particles comprising a phenolic resin system. Non-woven web 2 also contained 12 wt. % of polylactic acid binder fibers. Non-woven web 3 also contained 12 wt. % of polylactic acid binder fibers and 12 wt. % of solid binder particles comprising a phenolic resin system. Comparative non-woven web 1 contained the polyester fibers, the acrylic fibers, and the resin, but no binder fibers or particles. After formation, non-woven webs 1-3 were heated at a temperature of 200° C. for 2 minutes.

Table 1 shows various properties of non-woven webs 1-3 and comparative non-woven web 1. Unless otherwise specified, the properties were determined as described herein.

TABLE 1
Properties of Synthetic Non-woven Webs

| Non- | Basis | | | Mullen | Air | Stiff- |
|---|---|---|---|---|---|---|
| woven | Weight | Thickness | Tensile | Burst | Perm. | ness |
| web | (g/m²) | (mm) | (lb/in.) | (psi) | (cfm) | (mg) |
| Compar- | 84.6 | 0.627 | 13.3 | 28 | 21 | 889 |
| ative 1 | | | | | | |
| 1 | 85.2 | 0.691 | 11.8 | 35 | 24 | 1111 |
| 2 | 87.5 | 0.668 | 12.4 | 43.5 | 24 | 1689 |
| 3 | 85.9 | 0.747 | 16.2 | 51 | 23 | 1956 |

As shown in table 1, non-woven webs including at least one binder component in the form of a binder fiber and/or binder particle had a significantly higher Mullen Burst strength and stiffness than an essentially identical non-woven web lacking a binder component (i.e., comparative non-woven web 1). The non-woven web including at least one binder fiber and/or binder particle also had a higher air permeability than the comparative non-woven web. The non-woven web including both a binder fiber and a binder particle had the highest stiffness and Mullen Burst strength.

### Example 2

This example describes the mechanical and filtration properties of filter media comprising the non-woven webs of Example 1. The filter media including a non-woven web having binder fibers and/or binder particles had increased Mullen Burst strength, stiffness and substantially the same air permeability compared to a filter media including a non-woven web lacking a binder particle and a binder fiber.

Briefly, filter media were formed by forming a layer of fibrillated Lyocell fiber on top of the non-woven webs of Example 1. Filter media 1 was formed using non-woven web 1. Filter media 2 was formed using non-woven web 2. Filter media 3 was formed using non-woven web 3. Comparative filter media 1 was formed using comparative non-woven web 1. No additional layers were added to any of the filter media.

Table 2 shows various properties of filter media 1-3 and comparative filter media 1. Unless otherwise specified, the properties were determined as described herein.

TABLE 2
Properties of Filter Media

| | | | Second | | | | |
|---|---|---|---|---|---|---|---|
| | | | layer | | | | |
| | Basis | Thick- | basis | | Mullen | Air | Stiff- |
| Filter | Weight | ness | wt. | | Burst | Perm. | ness |
| Media | (g/m²) | (in.) | (g/m²) | Tensile | (psi) | (cfm) | (mg) |
| Compar- | 104.6 | 0.739 | 24.5 | 18.7 | 37 | 3 | 1956 |
| ative 1 | | | | | | | |
| 1 | 103.8 | 0.792 | 23.0 | 13.4 | 45 | 3 | 2823 |
| 2 | 106.2 | 0.742 | 25.2 | 17.3 | 52 | 3 | 3289 |
| 3 | 107.7 | 0.762 | 23.7 | 18.2 | 52 | 3 | 3178 |

As shown in Table 2, filter media 1-3 had increased Mullen burst strength and stiffness compared to comparative filter media 1 with substantially the same air permeability.

### Example 3

This example describes the filtration properties of filter media 3 in Example 2 compared to (i) comparative filter media 1 and (ii) comparative filter media 1 with a scrim layer (i.e., comparative 2). Filter media 3 had substantially the same efficiency and dust holding capacity as comparative filter media 1 and comparative filter media 1 with a scrim layer (i.e., comparative 2). The scrim layer of comparative 2 was formed on top of the second layer (i.e., directly adjacent to the second layer comprising the fibrillated Lyocell fibers).

Multipass filter test were performed on filter media 3 from Example 2 compared to comparative filter media 1 and comparative filter media 1 with a scrim layer (i.e., comparative 2) as described herein. The results of the Multipass filter tests are shown in Table 3.

TABLE 3
Multipass filter tests on various filter media.

| | Initial | Ave. | |
|---|---|---|---|
| | Particle | Particle | |
| Filter | Eff. (%) | Eff. (%) | DHC |
| Media | at 4 μm | at 4 μm | (g/m²) |
| Comparative 1 | 99.7 | 99.95 | 124 |
| Filter media 3 | 99.75 | 99.97 | 151 |
| Comparative 2 | 99.77 | 99.95 | 119 |

The filter media including a binder particle and a binder fiber had substantially the same filtration properties as a filter media lacking a binder particle and a binder fiber with and without a scrim. As shown in Example 2, the filter media including a binder particle and a binder fiber had a significantly greater Mullen Burst strength and stiffness than the filter media lacking a binder particle and a binder fiber.

### Example 4

This example describes the effect of varying the weight percentage of binder fibers on the mechanical and filtration properties of non-woven webs comprising cellulose fibers. The Mullen burst strength of the non-woven web increased with the amount of binder fiber.

Briefly, four non-woven webs were formed using a wet-laid process. Each non-woven web contained open Softwood pulp fibers having an average diameter of 45 microns, hardwood pulp fibers having an average fiber diameter of 16 microns, and about 8.5 wt. % binder resin. Non-woven web 4 also contained 10 wt. % of polylactic acid binder fibers. Non-woven web 5 also contained 20 wt. % of polylactic acid binder fibers. Non-woven web 6 also contained 30 wt. % of polylactic acid binder fibers. Comparative non-woven web 3 contained the open Softwood pulp fibers, the hardwood pulp fibers, polyester staple fibers having an average diameter of 1.0 microns, and a binder resin, but not any binder fibers. After formation, non-woven webs 4-6 were heated at a temperature of 200° C. for 2 minutes.

Table 4 shows various properties of non-woven webs 4-6 and comparative non-woven web 3. Unless otherwise specified, the properties were determined as described herein.

TABLE 4
Properties of Non-woven Webs With
Varying Amounts of Binder Fibers

| | | | | | Mullen |
|---|---|---|---|---|---|
| | Wt. % | Air | | | Burst |
| Non-woven | Binder | Perm. | Tensile | Elong. | Strength |
| webs | Fibers | CFM | (lb/in.) | (%) | (psi) |
| Comparative 3 | 0 | 22 | 13.3 | 4 | 10 |
| 4 | 10 | 31 | 13.3 | 2 | 11 |
| 5 | 20 | 43 | 19.2 | 3 | 21 |
| 6 | 30 | 41 | 17.3 | 3 | 22 |

As shown in Table 4, non-woven webs including cellulose fibers and binder components in the form of a binder fibers had significantly higher air permeability and a higher Mullen Burst strength than an essentially identical non-woven web lacking a binder component (i.e., comparative non-woven web 3). Both the air permeability and the Mullen Burst strength increased with increasing binder fiber content in the non-woven webs.

### Example 5

This example describes the mechanical and filtration properties of filter media comprising the non-woven webs of Example 4 and a filter media including a non-woven web containing binder particles and binder fibers (i.e., non-woven web 7). The filter media including a non-woven web having a binder fiber and/or binder particle had increased Mullen Burst strength, stiffness and substantially the same air permeability compared to a filter media including a non-woven web lacking a binder particle and a binder fiber.

Non-woven web 7 contained open Softwood pulp fibers having an average diameter of 45 microns, hardwood pulp fibers having an average fiber diameter of 16 microns, about 8.5 wt. % binder resin, 10 wt. % of polylactic acid binder fibers, and 6 wt. % solid binder particles comprising a phenolic resin system.

Briefly, filter media were formed by forming a layer of fibrillated Lyocell fibers on top of the non-woven webs of Example 4 and non-woven web 7. Filter media 4 was formed using non-woven web 4. Filter media 5 was formed using non-woven web 5. Filter media 6 was formed using non-woven web 6. Filter media 7 was formed using non-woven web 7. Comparative filter media 3 was formed using comparative non-woven web 3. No additional layers were added to filter media 4-7 and comparative filter media 3. Comparative filter media 4 was the same as comparative filter media 3, except the filter media included a scrim layer.

Table 5 shows various properties of filter media 4-7 and comparative filter media 3 and 4. Unless otherwise specified, the properties were determined as described herein. Table 6 shows various properties of the filter media. Multipass filter test were also performed on filter media 6 and 7 compared to comparative filter media 3 and as described herein. The results of the Multipass filter tests are also shown in Table 5.

TABLE 5
Properties of Filter Media

| | | Mullen | | | Initial | Ave. | |
|---|---|---|---|---|---|---|---|
| | Air | Burst | | Stiff- | Particle | Particle | |
| Filter | Perm. | Strength | Tensile | ness | Eff. (%) | Eff. (%) | DHC |
| Media | CFM | (psi) | (lb/in.) | (g) | at 4 μm | at 4 μm | (g/m²) |
| Compar- | 3 | 26 | 17.4 | 2934 | 99.88 | 99.98 | 122 |
| ative 3 | | | | | | | |
| Compar- | 3 | 30 | 15.6 | 3023 | 99.8 | 99.97 | 120 |
| ative 4 | | | | | | | |
| 4 | 3 | 27 | 12.7 | 3200 | — | — | — |
| 5 | 3 | 38 | | | — | — | — |
| 6 | 3 | 34 | 17.3 | 2956 | 99.82 | 99.89 | 105 |
| 7 | 3 | 48 | 23.5 | 3223 | 99.65 | 99.63 | 145 |

The filter media including non-woven webs including cellulose fibers and binder particles and/or binder fibers had significantly greater Mullen Burst strength while having substantially the same air permeability as compared to the comparative filter media lacking a binder component. The filter media including a binder particles and/or binder fibers had substantially the same filtration efficiency as the comparative filter media. Moreover, the filter media including a binder fiber and a binder particle had a significantly increased dust holding capacity.

### Example 6

This example describes the efficiency and dust holding capacity for filter media including a second layer containing varying amounts of binder fibers and/or binder particles. The presence of binder particles and/or binder fibers in the second layer did not adversely affect the efficiency and dust holding capacity of the filter media

Briefly, four filter media were tested. Each filter media contained the same non-woven web, but a different second layer. The non-woven web was comparative non-woven web 3, which did not contain a binder particle or binder fiber. Filter media 8 was formed by forming a layer (i.e., a second layer) comprising a blend of fibrillated Lyocell fibers and 10 wt. % of polylactic acid binder fibers on top of comparative non-woven web 3. Filter media 9 was formed by forming a layer comprising a blend of fibrillated Lyocell fibers and 10 wt. % of solid binder particles comprising a phenolic resin system on top of comparative non-woven web 3. Filter media 10 was formed by forming a layer comprising a blend of fibrillated Lyocell fibers and 5 wt. % of polylactic acid binder fibers and 5 wt. % of solid binder particles comprising a phenolic resin system. After formation, filter media 8-10 were heated at a temperature of 200° C. for 2 minutes. Comparative filter media 3 of Example 5 that contained no binder fibers or binder particles in either the base non-woven web or the second layer was used as a point of comparison. No additional layers were added to filter media 8-10 and comparative filter media 3.

Multipass filter tests were performed as described above to determine the initial and average efficiencies for the filter media for particles greater than 4 μm, as well as for determining dust holding capacities (DHC). Table 8 shows the efficiencies and dust holding capacity of the filter media.

TABLE 8
Results from multipass filter tests on various non-woven webs.

| | Initial | Ave. | |
|---|---|---|---|
| | Particle | Particle | |
| Filter | Eff. (%) | Eff. (%) | DHC |
| Media | at 4 μm | at 4 μm | (g/m²) |
| Comparative 3 | 99.88 | 99.98 | 122 |
| 8 | 99.58 | 99.91 | 135 |
| 9 | 99.81 | 99.97 | 131 |
| 10 | 99.73 | 99.96 | 112 |

As shown in Table 8, filter media including an efficiency layer containing binder particles and/or binder fibers had substantially the same efficiency and dust holding capacity as filter media lacking binder particles and/or binder fibers. Accordingly, the binder particles and/or binder fibers did not adversely affect the efficiency and dust holding capacity of the filter media, as filter media 8-10 each had similar measured values to that of comparative 3.

### Example 7

This example describes a non-woven web including cellulose fibers and a relatively large amount of binder fibers. Non-woven web 11 was formed using the same procedure as non-woven web 2 described above, except non-woven web 11 comprised 80 wt. % of polylactic acid fibers. After heating the non-woven web at 200° C. for 2 minutes, significant shrinkage was observed. As a result, testing of non-woven web 11 was unable to be performed. This result indicates that, while the addition of a certain amount of binder fibers improves strength, stiffness, air permeability, and performance, the addition of too high a quantity of binder fibers can have a deleterious effect on the structure of non-woven webs and/or filter media.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A wet-laid nonwoven web comprising:
a first plurality of fibers;
monocomponent binder fibers having a glass transition temperature of less than or equal to 70° C.; and
binder particles having a cross-sectional dimension greater than or equal to about 0.1 μm, wherein the wet-laid nonwoven web has an air permeability of greater than or equal to 1 CFM and less than or equal to 500 CFM and a stiffness of greater than or equal to 500 mg and less than or equal to 50,000 mg.

2. The wet-laid non-woven web of claim 1, wherein the monocomponent binder fibers are non-cylindrical.

3. The wet-laid non-woven web of claim 1, wherein the glass transition temperature of the monocomponent binder fibers is greater than or equal to about 20° C. and less than or equal to about 70° C.

4. The wet-laid non-woven web of claim 1, wherein the melting temperature of the monocomponent binder fibers is greater than or equal to about 100° C. and less than or equal to about 250° C.

5. (canceled)

6. The wet-laid non-woven web of claim 1, wherein the binder particles are cross-linked.

7. The wet-laid non-woven web of claim 1, wherein the wet-laid non-woven web has a dry Mullen burst strength of greater than or equal to 1 psi and less than or equal to 250 psi.

8. (canceled)

9. The wet-laid non-woven web of claim 1, wherein the weight percentage of the monocomponent binder fibers in the wet-laid non-woven web is less than or equal to about 50%.

10. The wet-laid non-woven web of claim 1, wherein the weight percentage of the binder particles in the wet-laid non-woven web is less than or equal to about 40%.

11. The wet-laid non-woven web of claim 1, wherein the first plurality of fibers comprises synthetic fibers and cellulose fibers.

12. The wet-laid non-woven web of claim 1, wherein the first plurality of fibers comprises fibrillated fibers and synthetic fibers.

13. The wet-laid non-woven web of claim 1, where the wet-laid non-woven web is pleated.

14. (canceled)

15. The wet-laid non-woven web of claim 1, wherein the monocomponent binder fibers have a melt flow index of less than or equal to 2500 g/10 minutes.

16. The wet-laid non-woven web of claim 1, wherein the monocomponent binder fibers comprise polylactic acid.

17. The wet-laid non-woven web of claim 1, wherein the binder particles comprise phenolic resin.

18. The wet-laid non-woven web of claim 1, wherein the binder particles are substantially uniformly distributed across the thickness of the wet-laid non-woven web.

19. The wet-laid non-woven web of claim 1, wherein the weight percentage of the monocomponent binder fibers in the wet-laid non-woven web is greater than or equal to about 10% and less than or equal to about 30%.

20. (canceled)

21. The wet-laid non-woven web of claim 1, wherein the binder fibers comprise polylactic acid, the weight percentage of binder fibers in the wet-laid non-woven web is greater than or equal to about 10% and less than or equal to about 30%, the binder particles comprise phenolic resin, the weight percentage of binder particles in the wet-laid non-woven web is greater than or equal to 0.2% and less than or equal to 25%, and the wet-laid non-woven web has a dry Mullen burst of strength of greater than or equal to 8 psi and less than or equal to 100 psi.

22. A filter media comprising:
a first layer comprising a first plurality of fibers and first monocomponent binder fibers having a glass transition temperature of less than or equal to 70° C.; and
a second layer comprising a second plurality of fibers, wherein the second layer has an air permeability of less than or equal to about 150 CFM, wherein a mean flow pore size of the second layer is less than a mean flow pore size of the first layer, wherein the filter media has a thickness of less than or equal to about 10 mm, and wherein the filter media has a dry Mullen burst strength of greater than or equal to about 5 psi and less than or equal to about 500 psi.

23. The filter media of claim 22, wherein the first layer comprises first binder particles.

24-43. (canceled)

44. The filter media of claim 22, wherein the first monocomponent binder fibers comprise polylactic acid, the weight percentage of binder fibers in the first layer is greater than or equal to about 10% and less than or equal to about 30%, and the filter media has a dry Mullen burst of strength of greater than or equal to 5 psi and less than or equal to 300 psi, and a stiffness of greater than or equal to 1,000 mg and less than or equal to 30,000 mg.

45. (canceled)
